(19) United States
(12) Patent Application Publication
(10) Pub. No.: US 2023/0065616 A1
(43) Pub. Date: Mar. 2, 2023

(54) TECHNIQUES FOR SCHEMA DRIFT DETECTION

(71) Applicant: Oracle International Corporation, Redwood Shores, CA (US)

(72) Inventor: Hari Bhaskar Sankaranarayanan, Bengaluru (IN)

(73) Assignee: Oracle International Corporation, Redwood Shores, CA (US)

(21) Appl. No.: 17/458,081

(22) Filed: Aug. 26, 2021

(51) Int. Cl. G06F 16/21; G06N 20/00; G06N 5/04

(52) U.S. Cl. CPC G06F 16/213; G06N 20/00; G06N 5/04

(57) ABSTRACT

A drift analysis system (DAS) is described that is capable of automatically detecting potential model schema drift issues when a machine learning model (MIL model), which has been trained using a particular training dataset, is used to make a prediction for a particular input provided to the model. The DAS performs one or more drift checks by comparing characteristics of the input to characteristics of the training dataset that was used to train the model that is being used to make a prediction for the input. Results obtained by the DAS from performing the drift checks may then be output along with the prediction made for the particular input. The one or more drift check results may be compiled into a drift report, which may be served concurrently with prediction results generated by the trained machine-learning model for the input.

### BACKGROUND

Recent years have seen a rapid increase in the adoption of Artificial Intelligence (AI) and machine learning (ML) solutions in various different industries and applications. For a typical ML solution, in a training phase, an ML model is trained and validated using some particular training dataset. Once the model has reached an acceptable level of accuracy in the training phase, the model is then deployed to a production environment where it is used to make predictions on real-time production data inputs. The performance of an ML model can, however, fluctuate over time for various reasons resulting in reduced accuracy of the predictions. One reason is due to model drift.

There are various types of model drift including concept drift, schema drift, and others. Schema drift generally occurs due to the production data inputs drifting away from the training data that was used to train the model that is being used to make predictions for the production inputs. This can happen for example, when the training data does not properly represent the production data inputs. As another example, schema drift can occur when, over time, the nature of the production data changes and diverges from the training data that was used to train an ML model. There are various causes of schema model drift such as missing values in the production inputs, discrepancies in the units of measures of the production and training data, outlier conditions for numerical or categorical data values, human data entry errors, and the like.

Detecting schema drift is a non-trivial problem and typically performed by data scientists whom need to have a deep understanding of the training data, the production data, and the model being used for the predictions. Schema drift is thus difficult to detect, as a production dataset experiencing schema drift may remain structurally useable, but the data and attributes contained in the dataset may deviate from the dataset used to train the ML models, causing errors in the predictions made by ML models.

### BRIEF SUMMARY

The present disclosure relates to model drift detection in situations where trained machine learning (ML) models are used to make predictions for inputs to the models. A drift analysis system is described that is capable of automatically detecting potential model schema drift issues when an ML model, which has been trained using a particular training dataset, is used to make a prediction for a particular input provided to the model. Various embodiments are described herein, including methods, systems, non-transitory computer-readable storage media storing programs, code, or instructions executable by one or more processors, and the like.

The drift analysis system embodiments described herein provide an automated solution for detecting schema drift. Based upon the characteristics of the input data points and the training dataset used to train an ML model, the drift analysis system is programmed to perform a set of schema drift checks in an automated manner substantially free of any human input or intervention. Each drift check is configured to evaluate the potential for model drift based upon certain criteria. For a particular input and a prediction generated by an ML model for that input, the results obtained by the drift analysis system from performing the drift checks may be collated in a drift analysis report and the report may be output to a user along with the prediction made using the ML model. The results generated and output by the drift analysis system provide an early warning to the consumer of the prediction as to the accuracy of the prediction made by the model and how the prediction may have been impacted by schema model drift.

The drift analysis system may be programmed to perform multiple drift checks in an automated manner, where each check is based upon certain characteristics of the particular input and the particular training dataset. Each drift check is configured to evaluate the potential for model drift based from a particular aspect. The results obtained by the drift analysis system from performing the drift checks may then be output along with the prediction made using the ML model. These results provide additional information to a consumer of the prediction regarding the accuracy of the prediction made by the model and the potential impact upon the prediction due to model schema drift. The drift check results generated and output by the drift analysis system thus can provide an early warning to the consumer as to the accuracy of the prediction.

In certain embodiments, a drift analysis system may communicate with a prediction service configured to input an input data point (i.e., an data value grouping that is a subset of a dataset) and output prediction data. The prediction service may send, to the drift analysis system, data that will be used to generate a prediction result. For example, the prediction service may send, to the drift analysis system, the input data point and trained ML model information relating to a trained ML model which will output the prediction result based on the input data point.

The drift analysis system may access profile information associated with training dataset profile information that is associated with the trained ML model relating to the trained model information. The training dataset profile information may indicate a permissible data configuration for the input data point that will be input to the trained ML model of the prediction service. For example, the training dataset profile information may specify a range of numerical values that numerical values within the input data point are expected to operate be within. The training dataset profile information may be previously associated in memory with a particular trained ML model or may be generated in response to receiving the trained model information from the prediction service.

A serverless function system may communicate with the drift analysis system to facilitate the processes described herein. For example, the drift analysis system may utilize a communication channel to perform serverless function calls to the serverless function system. The serverless function system will then responsively implement one or more serverless functions to perform processes as serverless functions. For example, a drift analysis system may make one or more serverless function calls to a serverless function system to perform schema drift testing functions. The schema drift testing functions are performed as serverless functions and the results of the testing functions are returned to the drift analysis system.

The set of one or more drift check results may be compiled and used by the drift analysis system to generate a drift report. The drift report may contain report information related to the comparison be may be dispatched to the prediction service to serve the report concurrently with prediction data output from the trained model. The drift report may contain report information related to the one or more drift checks performed and the corresponding drift check results. The drift report may be sent to the prediction service, which will serve both the prediction result and the drift report together. Thus, the system may operate as an early warning system for detecting schema drift in a dataset comprising the input data point concurrently to serving the prediction result. Schema drift is the movement of the composition of a dataset away from an original baseline configuration that the dataset was created with. This can be contrasted with model drift, which is the movement of the composition of a trained model away from an original baseline configuration that the model was trained with. Model drift will not be addressed in this application.

The set of one or more drift check results may also be used to determine one or more downstream actions to perform in response to the generation of the one or more drift check results. For example, one downstream action may be generating and sending, based on the one or more drift check results, a message to a data scientist of an enterprise that an input data point has experienced schema drift, and thus a corresponding dataset may have experienced schema drift as well. Another downstream action may be preventing further dissemination of the prediction data generated at the prediction service when a subset of the one or more drift checks do not conform to a threshold of drift allowability. Yet another downstream action may be sending the prediction data and the drift report to a client that supplied the input data point originally.

The drift analysis system may be offered as a cloud service by a cloud services provider in some embodiments. The services are made available to a customer or subscriber who subscribes to this and other services provided by the cloud services provider.

In certain embodiments, techniques are disclosed wherein a drift analysis system performs processing comprising receiving, by a first computing device, an input data point and model information identifying a trained model that is to be used to generate a prediction for the input data point; performing, by the first computing device, a set of one or more drift checks for the input data point and for the trained model using training dataset profile information for the trained model, the set of one or more drift checks including a first drift check, wherein the training dataset profile information for the trained model comprises information about a training dataset used to train and generate the trained model, and wherein performing the set of one or more drift checks comprises comparing the input data point to the training dataset profile information; and generating, by the first computing device, a report comprising information identifying at least the first drift check and an associated first result generated from performing the first drift check; and outputting the report.

In certain embodiments, the processing further comprises receiving, by a second computing device, the input data point; generating, by the second computing device, the prediction for the input data point using the trained model, wherein the outputting the report comprises communicating the report from the first computing device to the second computing device; and outputting, by the second computing device, the prediction along with the report.

In certain embodiments, the processing further comprises accessing, by the first computing device and based upon the model information, the training dataset profile information from a memory location.

In certain embodiments, the processing further comprises identifying, by the first computing device, the training dataset used to train and generate the trained model; and generating, by the first computing device, at least a portion of the training dataset profile information based upon the training dataset.

In certain embodiments, the training dataset comprises a plurality of training input data points, each training data point in the plurality of training input data points comprising a plurality of columns; the training dataset profile information comprises information identifying the plurality of columns; and comparing the input data point to the training dataset profile information comprises determining whether the input data point comprises a value for each column in the plurality of columns.

In certain embodiments, the training dataset comprises a plurality of training input data points, each training input data point in the plurality of training input data points comprising a plurality of columns; the training dataset profile information comprises, for a first column in the plurality of columns, information identifying a set of metrics determined based upon numerical values in the first column for the plurality of training input data points; and comparing the input data point to the training dataset profile information comprises, for a particular column in the input data point corresponding to the first column, comparing a value in the particular column in the input data point to one or more metrics in the set of metrics.

In some further embodiments, the set of metrics includes a first metric indicative of a lowest numerical value in the first column in the training dataset and a second metric indicative of a highest numerical value in the first column in the training dataset; and comparing the value in the particular column in the input data point to one or more metrics in the set of metrics comprises determining whether the value in the particular column is lower than the first metric and higher than the second metric. In other further embodiments, the set of metrics includes a first metric indicative of a mean values based upon numerical values in the first column in the training dataset; and comparing the value in the particular column in the input data point to one or more metrics in the set of metrics comprises comparing the value in the particular column to the first metric.

In certain embodiments, the training dataset comprises a plurality of training input data points, each training input data point in the plurality of training input data points comprising a plurality of columns; the training dataset profile information comprises, for a first column in the plurality of columns, information identifying a set of different categorical values in the first column for the plurality of training input data points; and comparing the input data point to the training dataset profile information comprises, for a particular column in the input data point corresponding to the first column, comparing a value in the particular column in the input data point to the set of different categorical values.

In certain embodiments, the training dataset comprises a plurality of training input data points, each training input data point in the plurality of training input data points comprising a plurality of columns, the plurality of columns corresponding to a plurality of column types; the training dataset profile information comprises information indicative of the plurality of column types; and comparing the input data point to the training dataset profile information comprises, for a set of column types corresponding to a set of columns in the input data point, determining if the set of column types is same as the plurality of column types indicated in the training dataset profile information.

In certain embodiments, performing the set of one or more drift checks comprises, for at least one drift check in the set of one or more drift checks, calling a serverless function to perform the at least one drift check.

In certain embodiments, the training dataset comprises a plurality of training input data points, each training input data point in the plurality of training input data points comprising a plurality of columns; the training dataset profile information comprises, for a first column in the plurality of columns, information identifying a particular unit of measure associated with values in the first column in the plurality of training input data points; and comparing the input data point to the training dataset profile information comprises, for a particular column in the input data point corresponding to the first column, determining whether a unit of measure associated with a value in the particular column in the input data point is same as or different from the particular unit of measure.

In certain embodiments, a system, such as a drift analysis system, comprises a processor and memory including instructions that, when executed by the processor, cause the device to perform the processing described herein. In another example embodiment, a non-transitory computer-readable medium stores a plurality of instructions executable by one or more processors to cause the one or more processors to perform the processing described herein.

The foregoing, together with other features and aspects will become more apparent upon referring to the following specification, claims, and accompanying drawings.

### BRIEF DESCRIPTION OF THE DRAWINGS

FIG. 1 is a simplified diagram of a distributed environment incorporating a drift analysis system, according to various embodiments.

FIG. 2 depicts a simplified flow diagram illustrating an example process for generating and outputting, by a drift analysis system, a drift report, according to various embodiments.

FIG. 3 depicts a simplified flow diagram illustrating an example process for generating and outputting, by a prediction service, a prediction report and a drift report generated by a drift analysis system, according to various embodiments.

FIG. 4 depicts a simplified flow diagram illustrating an example decision flow for retrieving training dataset profile information, according to various embodiments.

FIGS. 5A and 5B depict a simplified flow diagram illustrating an example process for performing a set of checks on an input data point based on a profile, according to various embodiments.

FIG. 6 depicts an example user interface for facilitating generation of a combined drift report and prediction report, according to various embodiments.

FIG. 7 is a block diagram illustrating one pattern for implementing a cloud infrastructure as a service system, according to at least one embodiment.

FIG. 8 is a block diagram illustrating another pattern for implementing a cloud infrastructure as a service system, according to at least one embodiment.

FIG. 9 is a block diagram illustrating another pattern for implementing a cloud infrastructure as a service system, according to at least one embodiment.

FIG. 10 is a block diagram illustrating another pattern for implementing a cloud infrastructure as a service system, according to at least one embodiment.

FIG. 11 is a block diagram illustrating an example computer system, according to at least one embodiment.

### DETAILED DESCRIPTION

In the following description, for the purposes of explanation, specific details are set forth in order to provide a thorough understanding of certain aspects. However, it will be apparent that various aspects may be practiced without these specific details. The figures and description are not intended to be restrictive. The word “exemplary” is used herein to mean “serving as an example, instance, or illustration.” Any aspect or design described herein as “exemplary” is not necessarily to be construed as preferred or advantageous over other aspects or designs.

The present disclosure relates to model drift detection in situations where trained machine learning (ML) models are used to make predictions for inputs to the models. A drift analysis system is described that is capable of automatically detecting potential model schema drift issues when an ML model, which has been trained using a particular training dataset, is used to make a prediction for a particular input provided to the model.

As described above, the performance of an ML model can fluctuate and diminish due to model schema drift, which generally occurs due to the production data inputs drifting or diverging away from the training data that was used to train the model that is being used to make predictions for the production inputs. This can occur when, over time, the nature of the production data changes and diverges from the training data that was used to train an ML model. There are various causes of schema model drift such as missing values in the production inputs, discrepancies in the units of measures of the production and training data, outlier conditions for numerical or categorical data values, human data entry errors, and the like. Detecting schema drift is a non-trivial problem and typically performed by data scientists who need to have a deep understanding of the training data, the production data, and the model being used for the predictions. Further, any such analysis by the data scientist is done a long time after the actual prediction is made. As a result, at the time of the prediction, the user of the prediction has no idea of the potential impact of schema drift on the prediction made. The user may rely on the prediction, possibly leading to adverse consequences. Schema drift is thus difficult to detect. More importantly, it can adversely impact predictions made in the production environment using ML models, which can have negative or even catastrophic effects.

The drift analysis system embodiments described herein provide an automated solution for detecting schema drift. Based upon the characteristics of the input data points and the training dataset used to train an ML model, the drift analysis system is programmed to perform a set of schema drift checks in an automated manner substantially free of any human input or intervention. Each drift check is configured to evaluate the potential for model drift based upon certain criteria. For a particular input and a prediction generated by an ML model for that input, the results obtained by the drift analysis system from performing the drift checks may be collated in a drift analysis report and the report may be output to a user along with the prediction made using the ML model. The results generated and output by the drift analysis system provide an early warning to the consumer of the prediction as to the accuracy of the prediction made by the model and how the prediction may have been impacted by schema model drift.

The drift analysis system may be programmed to perform multiple drift checks in an automated manner, where each check is based upon certain characteristics of the particular input and the particular training dataset. Each drift check is configured to evaluate the potential for model drift based from a particular aspect. The results obtained by the drift analysis system from performing the drift checks may then be output along with the prediction made using the ML model. These results provide additional information to a consumer of the prediction regarding the accuracy of the prediction made by the model and the potential impact upon the prediction due to model schema drift. The drift check results generated and output by the drift analysis system thus can provide an early warning to the consumer as to the accuracy of the prediction.

In certain embodiments, the drift analysis system is used in conjunction with a prediction system or service. The prediction system may receive an n-dimensional data point as input from a user for which a prediction is to be made. The prediction system may use a particular trained ML model to generate a prediction for the input. The prediction service may call upon the services of the drift analysis system to perform schema drift analysis based upon the input and the model used by the prediction service for generating the prediction. The drift analysis system may perform the drift analysis based upon the characteristics of the input and the training dataset that was used to train the model. The drift analysis may include performing multiple schema drift checks. Results obtained by the drift analysis system for the various checks may then be communicated to the prediction system. The prediction system may then output both the prediction and the drift results to the user. In this manner, the user is provided both the prediction and the drift analysis results indicative of how schema drift may impact the prediction. The drift analysis result provide the user a better picture of the accuracy of the prediction made using the ML model.

The drift analysis system may perform one or more different schema drift checks. These checks may include, for example, a check to see if a value is missing in the input, outlier data point checks for numerical and/or categorical data values, category mismatch checks, checks to identify any mismatches in units of measure, and the like. In certain implementations, multiple of these checks may be performed in parallel to reduce the time needed for performing the checks. In certain implementations, the drift analysis system may use serverless functions to perform the various schema drift checks. The serverless functions may be hosted and executed in a cloud hosted environment upon execution requests sent by the drift analysis system.

As part of its processing for performing drift checks, the drift analysis system may determine characteristics of the input data point and characteristics of the training dataset used to train the model to be used for the prediction. For example, with respect to the input data points, the drift analysis system may determine if there are any values missing in the input. For characteristics of the training dataset, the drift analysis system may first determine if there is any information stored for the model (e.g., profile information for the model) that identifies characteristics of the training dataset used to train the model. If so, drift analysis system may use this information for performing the drift checks. Else or additionally, the drift analysis system may identify the training dataset used for training the model and determine if there is any information stored for the training dataset (e.g., training dataset profile information) that identifies characteristics of the training dataset. If so, drift analysis system may use this information for performing the drift checks. Else or additionally, the drift analysis system may analyze the training dataset to identify characteristics of the training dataset and use them for performing the drift checks.

Performance of the drift checks may involve comparing the characteristics of the input data point to the characteristics of the training dataset used to train the trained model that is to be used for making a prediction for the input data point. For example, a drift check performed by the drift analysis system may involve checking the schema of the training dataset (e.g., check the expected dimensions/columns) and determining if the input data point is missing any values for one or more dimensions. If so, the result for the check may flag this missing value. As another example, for dimensions/columns containing numerical values, the drift analysis system may compare the corresponding numerical value in the input data point and compare it to statistical metadata stored about that dimension/column in the training dataset. For example, this statistical metadata may include information such as the maximum value in the column in the training dataset, the minimum value in the column in the training dataset, the average or median value in the column in the training dataset, and the like.

These comparisons enable the drift analysis system to determine an flag any outliers. For example, if the value in the input data point for a column is outside the minimum and maximum (i.e., is out of range) values for that column in the training dataset. Similar checks may also be done for columns/dimensions storing categorical values. Any such outliers may be flagged in the results of the drift checks. As another example, the drift analysis system may compare the unit of measure associated (e.g., miles, seconds, etc.) with a column/dimension in the training dataset and check if the corresponding column value in the input data point has the same unit of measure or whether there is a mismatch. Such mismatches may be flagged by the drift analysis system in the drift analysis results.

The results obtained by the drift analysis system from performing the various drift checks may then be output to a user along with the prediction made using the model. In certain implementations, the drift analysis may generate a drift analysis report that aggregates the set of one or more drift check results. An example drift analysis report may include information identifying the one or more drift checks that were performed and the corresponding drift check results. The drift report may also contain information identifying the input, the model used for the prediction, and the prediction. In certain implementations, the prediction service may serve both the prediction result and the drift report together to the requesting user.

In certain implementations, the set of one or more drift check results may also be used to determine and trigger one or more downstream actions to be performed in response to the results. For example, if the result of a drift check is determined to be above (or below) some threshold value, one or more downstream actions may be triggered. These actions may include, for example, generating and sending one or more messages to a particular receiver (e.g., a data scientist of an enterprise) alerting/warning the receiver of the drift results. As another example, a downstream action may include preventing the prediction generated by the prediction service from being output to a user. Instead, a message may be output that there is an error in the prediction due to model schema drift and the drift results may be output to the user.

As described above, the drift analysis system may be provided in conjunction with a prediction system/service. In certain implementations, the model drift analysis functionality provided by the drift analysis system may be offered as a cloud service by a cloud services provider. For example, the service may be provided under a Software-as-a-Service (SaaS) model and can be subscribed to by multiple subscribers. In certain embodiments, multiple different prediction systems/services may use the services provided by the drift analysis system.

As described in this disclosure, the drift analysis system provides an automated solution for identifying possible schema drift situations when a model is used to make a prediction for a particular input. The drift analysis system performs a variety of drift checks based upon the characteristics of the input data point and the training dataset used to train the model is used for making the prediction. Further, the results of the drift checks are provided or served to a user at the same time as the prediction is presented to the user. The drift checks results thus act as alerts or warnings to the user with respect to the prediction made. The drift analysis system thus acts as an “early warning” schema drift detection system providing a context regarding the prediction made using an ML model. The drift analysis system is implemented in a distributed manner allowing for the drift checks to be performed in a fast and efficient manner such that drift analysis results can be presented to the user along with the predictions. Various efficient compute techniques such as using parallel computations techniques, using serverless functions may be used for performing the schema drift checks. The drift analysis system can thus be scaled as needed depending upon the demand for its services without causing compute bottlenecks. In certain implementations, actions responsive to drift check results may be programmed or performed in an automated manner. This is instrumental in improving the safety and reliability of prediction systems and reduce and/or eliminating the need for manual intervention. For example, if a particular prediction for a particular input is deemed to be potentially inaccurate due to model drift problems, this may be immediately flagged when the prediction is made, and appropriate downstream actions commenced in response. From the user's perspective this increases the reliability of the prediction system/service since the user is assured that, from the multiple issues that can degrade the performance of an ML model and negatively affect the accuracy of predictions made using the ML model, at least the model drift issues are automatically flagged at the time the prediction is made or output to the user. This provides several technical benefits over the reactionary post hoc analysis that is done in conventional prediction systems.

The drift analysis system thus provides an early warning system for schema drift detection. The early warning system may inform customers of a prediction service that particular prediction results may have been generated based on input data points that have experienced schema drift. Customers and data scientists may then determine how to utilize the prediction results, such as by changing the training dataset that is used to train the model so that it is a better representation of the input data points. The early warning system may thus prevent further erroneous and problematic prediction results from being served in the future.

### Example Systems and Embodiments

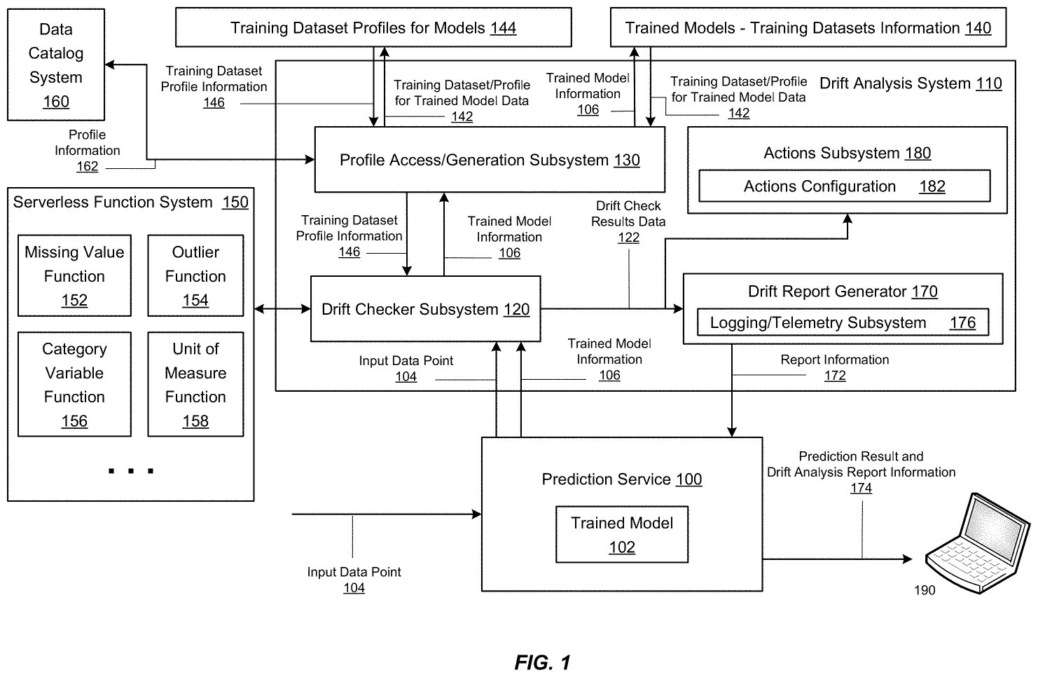

FIG. 1 is a simplified diagram of a distributed environment incorporating a drift analysis system, according to various embodiments. As shown in FIG. 1, the distributed environment comprises multiple systems and subsystems. The distributed environment comprises prediction service 100. Prediction service 100 may be a service implemented on a computing device, such as a server system. Prediction service 100 may be a service configured to receive an input data point 104 to responsively generate output comprising a prediction result. For example, prediction service 100 may be a service configured to input a received input data point into a trained ML model, such as trained model 102, to produce a prediction result.

The trained model 102 may be a trained ML model configured to receive some data as input and output prediction data. For example, trained model 102 may be a convolutional neural network ML model configured to map an input data point to one or more nodes in a convolutional neural network. The one or more nodes in the convolutional neural network may then be utilized to generate an output comprising prediction data. The trained model 102 may be a ML model which was previously trained with some training dataset(s) to enable to trained model 102 to generate prediction results. For example, one or more training datasets may be used to train a ML model to generate a trained model 102. Accordingly, the trained model 102 inherently comprises some aspects of the training dataset(s) used to train the trained model 102.

Prediction service 100 may be configured to send input data point 104 and some trained model information 106 to another service or system. Trained model information 106 may be some information or data that may be used to identify a trained ML model such as trained model 102. In some embodiments, the trained model information 106 is metadata describing the trained model 102. In some embodiments, the trained model information 106 is a location of a trained model in a computer memory. In some embodiments, the trained model information 106 is the trained model itself.

Prediction service 100 sends the input data point 104 and some trained model information 106 to drift analysis system 110. Drift analysis system 110 may be a system implemented on one or more computing devices, such as server devices. Drift analysis system 110 may be a system configured to facilitate analysis of an input data point 104 based on some trained model information 106. Drift analysis system 110 comprises drift checker subsystem 120. Drift checker subsystem 120 is a subsystem of drift analysis system 110 configured to receive the input data point 104 and trained model information 106 from prediction service 100. In some embodiments, drift checker subsystem 120 is a centralized subsystem for facilitating a drift analysis of the input data point 104. For example drift checker subsystem 120 may be configured to store the input data point 104, trained model information 106 and training dataset profile information 146 for analyzing the input data point 104. To retrieve the training dataset profile information 146, drift checker subsystem 120 sends the trained model information 106 to a Training dataset profile access/generation subsystem 130.

Training dataset profile access/generation subsystem 130 is a subsystem of drift analysis system 110 configured to determining and retrieve a particular set of training dataset profile information 146 corresponding to a profile for trained model 102. Training dataset profile information for the trained model 102 may be stored in a memory from which the training dataset profile information may be retrieved. The memory location of the training dataset profile information may be indicated by some data structure relating the trained model 102 to the training dataset profile information. The relational data structure identifying the training dataset profile information may be stored in some trained models—training datasets information 140 of the distributed system. Training dataset profile access/generation subsystem 130 may be configured to send the trained model information 106 to trained model—training datasets information 140. Trained models—training datasets information 140 may be information identifying a set of trained models and training datasets that were used to train the respective trained models.

Trained models—training datasets information 140 utilizes the trained model information 106 to identify some training dataset/profile for trained model data 142. In some embodiments, the training dataset/profile for trained model data 142 may identify a location of a trained model in a training dataset profiles for models entity 144. In some embodiments, training dataset/profile for trained model data 142 may be mapping data indicating a mapping between the trained model 102 identified by trained model information 106 and some training dataset profile information 146. In some embodiments, training dataset/profile for trained model data 142 may be mapping data indicating a mapping between the trained model 102 identified by trained model information 106 and some training datasets. In some embodiments, training dataset/profile for trained model data 142 may be data indicating that training dataset profile information does not exist for a particular trained model.

Training dataset profile access/generation subsystem 130 may be configured to send the training dataset/profile for trained model data 142 to profile information 144. Training dataset profiles for models may be a collection of training dataset profile information that has been generated for multiple trained models, such as trained model 102. Training dataset profiles for models 144 may utilize trained dataset/profile for trained model data 142 to identify training dataset profile information 146 corresponding to the trained model 102. In some embodiments, training dataset profiles for models 144 may determine that training dataset profile information 146 corresponding to trained model 102 does not exist, and may send an indication to Training dataset profile access/generation subsystem 130 that the training dataset profile information 146 does not exist. In some embodiments, training dataset profiles for models 144, training models —training datasets information 140, or both are part of drift analysis system 110.

Training dataset profile information 146 may be any kind of data/information associated with a training dataset that was previously used to train trained model 102. For example, training dataset profile information 146 may include specifications for the training dataset, such as a number of columns/attributes within the training dataset, metric information for the dataset (e.g. minimum, maximum, mean, median, and other numerical metrics for numeric data within the dataset), category values for a number of categorical attributes/columns of the training data, etc. This information will be used to conduct drift analysis on the input data point 104.

Training dataset profile access/generation subsystem 130 sends and receives profile information 162 to and from data catalog system 160. In some embodiments, profile information 162 relating to the training dataset profile information 146 may be sent to data catalog system 160 from Training Dataset Profile Access/Generation Subsystem 130. Data catalog system 160 may utilize received profile information 162 to determine one or more additional aspects of the training dataset profile information 146 stored at data catalog system 160. In some examples, data catalog information 160 may utilize profile information 162 to determine updated aspects of training dataset profile information 146, such as additional attributes of training dataset profile information 146. In some embodiments, data catalog system 160 may utilize profile information 162 to determine some training dataset(s) used to train a trained model 102 corresponding to the training dataset profile information 146. In some embodiments, data catalog system 160 may utilize profile information 162 to determine some threshold values/metrics for the training dataset profile information, such as min, max, average, median, or other values related to some training dataset(s) used to train the trained model 102. The data catalog system 160 may return this information as profile information 162 to Training Dataset Profile Access/Generation Subsystem 130. Data catalog system 160 will be discussed in further detail below.

In embodiments where training dataset profile information 146 does not exist for a trained model 102, Training dataset profile access/generation subsystem 130 may be configured to generate training dataset profile information relating to a trained model 102. For example, Training dataset profile access/generation subsystem 130 may be configured to use some training dataset(s) used to train the trained model 102 to generate training dataset profile information. Training dataset profile access/generation subsystem 130 sends training dataset profile information 146 to drift checker subsystem 120.

Drift checker subsystem 120 is in communication with serverless function system 150. Drift checker subsystem 120 may send data and information, such as input data point 104 and training dataset profile information 146 to serverless function system 150. Serverless function system 150 may be a service or system provisioned among multiple computing devices. Serverless function system 150 may therefore operate independent of a particular hosting device and may be accessible by many other devices over a network and/or cloud infrastructure.

In various embodiments, a serverless function system, such as serverless function system 150, comprises one or more components for executing serverless functions. A serverless function is a process/function implemented in a distributed computing environment. The distributed computing environment includes a client device and a server device. The client device may be a device configured to generate and dispatch a function call to the server device. The service device will supply the infrastructure resources and components to execute the function. The result of the executed function will then be returned to the client device as a result. In some embodiments, function calls generated by the client device may be queued and executed at the server device in a particular order, such as a first-in-first-out configuration.

In various embodiments not depicted in FIG. 1, drift analysis system 110 may submit serverless function calls to serverless function system 150 as part of a serverless architecture. For example, drift checker subsystem 120 may subset one or more serverless check function calls to serverless function system 150. The calls may include information for performing the serverless check functions, such as the input data point and the training dataset/profile data. The calls may be routed through a routing gateway and processed by serverless function system 150. Serverless function system may utilize components stored thereon and/or other computer resources to execute serverless drift check functions. In some embodiments, serverless function system 150 may route the function calls to another system for performing the serverless drift check functions. Once the one or more serverless drift check functions are executed and a result is generated, the result may be returned to the original calling device/system through the routing gateway. For example, once serverless function system 150 generates a result by executing one or more serverless drift check functions, the result is returned to drift analysis system 110 via drift checker subsystem 120.

Serverless function system 150 comprises one or more components for implementing or executing a number of serverless functions for performing checks for schema drift according to a input data point 104 and training dataset profile information 146. In some embodiments, serverless function system 150 may also implement/execute serverless functions for performing checks based on profile information 162 from a data catalog system 160. Serverless function system 150 comprises components for implementing/executing serverless functions, for example, missing value function 152. Missing value function 152 may be a function or set of steps configured to determine, when executed, whether an input data set 104 is missing data values from the input dataset 104. For example, a trained model 102 may utilize input comprising a plurality of input data values. The missing value function 152 may determine whether the input data point 104 comprises a number of input data values greater than, less than, or equal to the expected number of input data values.

Serverless function system 150 further comprises components for implementing/executing outlier function 154. Outlier function 154 may be a function or set of steps configured to determine, when executed, whether any input data values of the input data point 104 are outside of an acceptable value range specified by the training dataset profile information 146. For example, input data values of the input data point may be compared to a range or set of acceptable values to determine if any input data values are outside the range/set and/or how far outside the range a value may be.

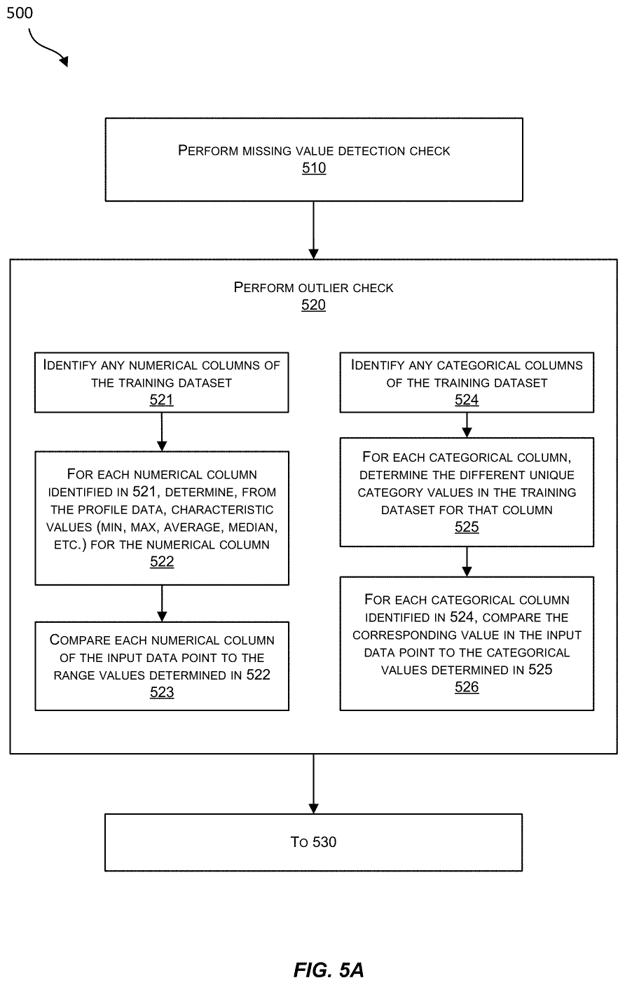

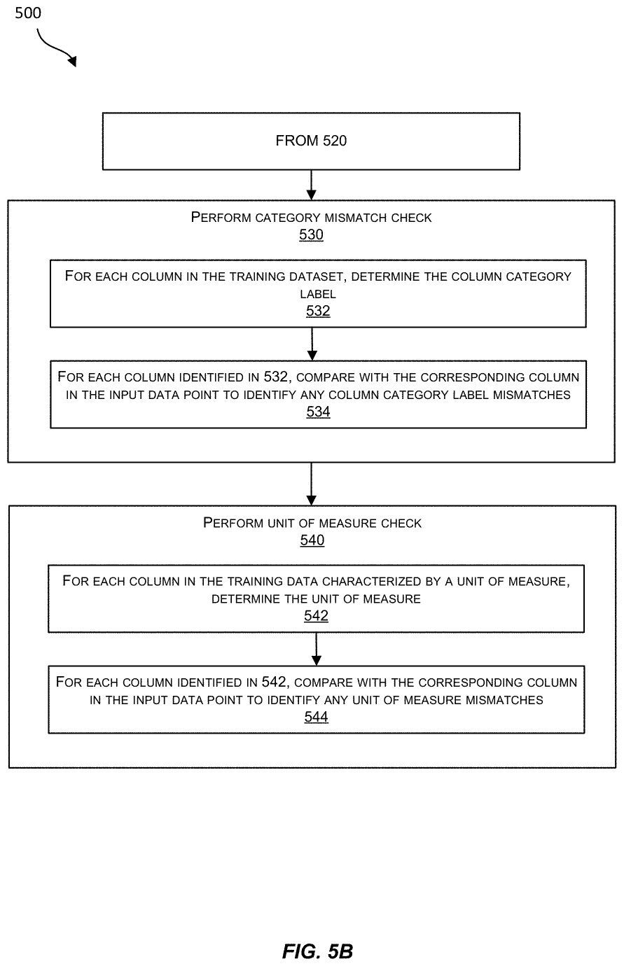

Serverless function system 150 further comprises components for implementing/executing category variable function 156. Category variable function 156 may be a function or set of steps configured to determine, when executed, whether any input data values of the input data point 104 do not correspond to a category of a training dataset used to train the trained model 102. Serverless function system 150 further comprises components for implementing/executing unit of measure function 158. Unit of measure function 158 may be a function or set of steps configured to determine, when executed, whether any input data values of the input data point 104 do not correspond to a unit of measure of a training dataset used to train the trained model 102. Each of the functions 152-158 will be discussed further with respect to FIGS. 5A and 5B below. It will be appreciated, as depicted in FIG. 1, that there may be any number of drift checks or functions performable by serverless function system 150. In some embodiments, the drift checks/functions are performed by drift analysis system 110 or a subsystem thereof.

Serverless function system 150 may send, to drift checker subsystem 120, a set of one or more drift check results performed by serverless function system 150 using functions 152-158. The set of one or more drift check results may be results of the functions 152-158 performed by serverless function system 150. For example, each of functions 152-158 may generate one or more results based on a comparison between the input data point 104 and the training dataset profile information 146/training dataset. The one or more results of each check may be compiled into a set of drift check results that may be sent to drift checker subsystem 120. For example, a drift check result of the outlier function 154 may comprise difference data corresponding to difference values measured between an input data value and min, max, median, mean, or other values generated based on the training dataset profile information 146/training dataset.

In some embodiments, drift checker subsystem 120 may compile the set of one or more results into drift check results data 122. For example, drift check results data 122 may be a single dataset comprising drift check results taken from a number of results of checks performed by functions of serverless function system 150. Drift checker subsystem 120 sends drift check results data 122 to other entities/subsystems within drift analysis system 110. For example, drift checker subsystem 120 sends drift check results data 122 to drift report generation 170. Drift report generator 170 may be a subsystem/generator entity within drift analysis system 110 for generating a drift report. A drift report may be a comprehensive document details the set of one or more results of the comparisons performed at the serverless function system 150. In some embodiments, drift report generator 170 may be configured to generate drift analysis data based on the generated drift report. For example, drift analysis data generated by the drift report generator may be a prediction that an input data point 102 has experienced schema drift according to the set of one or more drift check results. The drift report may comprise drift information 172. Drift information may be some readable and/or utilizable information relating to the drift report. For example, report information 172 may be a text-based digital document comprising information related to the set of one or more drift check results.

Drift report generator 170 sends report information 172 to prediction service 100. Prediction service 100, concurrent with the generation of the drift report information or any process preceding it, generate a prediction result using the input data point 104 as input to trained model 102. The prediction service may combine the prediction result output from the trained model 102 with the report information 172 received from the drift report generator 170. The prediction service 100 may send the prediction result and drift analysis report information 174 to a client device 190. In some embodiments, a client device 190 is a device used by a data scientist. In some embodiments, the client device 190 is a device used by a customer/user that originally input the input data point 104 to generate the prediction result. In some embodiments, prediction service 100 is a part of drift analysis system 110 and is configured to server predictions as a subsystem thereof.

In certain implementations, drift report generator 170 may comprise a logging/telemetry subsystem 176. Logging/telemetry subsystem 176 may be a subsystem configured to collect and publish results, such as report information 172. For example, logging/telemetry subsystem 176 may publish results of a drift report to cloud-based service for tracking drift in datasets. The published drift results may be reviewed and utilized as part of the cloud-based service to review and/or modify datasets.

Drift checker subsystem 120 also sends drift check results data 122 to actions subsystem 180. Actions subsystem 180 is a subsystem operating within drift analysis system 110 configured to cause some downstream action based on the drift check results data 122. Actions subsystem 182 may be communicatively coupled to a separate system or another system within drift analysis system 110. For example, action subsystem 110 may be coupled to prediction service 100 to affect the manner in which prediction service 100 servers the prediction result and drift analysis report information 174. In another example, action subsystem 110 is coupled to profile access/generation subsystem to cause sending some generated training dataset profile information 146 for storage at training dataset profiles for models 144. In still other embodiments, actions subsystem 180 is coupled to a message dispatch system to cause dispatch of the drift check results data to an entity through a separate message.

Actions subsystem 180 may comprise actions configuration 182. Actions configuration 182 may be a configuration or set of information which affects the function of actions subsystem 180. Actions configuration 182 may comprise one or more rules or specifications for how actions subsystem 180 may cause downstream actions. For example, actions configuration 182 may contain a threshold of “acceptable” schema drift present in an input data point. In response to determining that a level of schema drift experiences by input data point 104 exceeds the threshold, actions configuration 182 may allow actions subsystem 180 to perform some downstream action.

A data catalog system, such as a data catalog system may be implemented according to certain embodiments.

A data catalog system provides various functionalities that enable organized inventories to be generated and used by enterprise users. For example, a data catalog system provides a discovery mechanism for discovering datasets for an enterprise. A data catalog system provides harvesting capabilities for harvesting metadata associated with the original datasets. A data catalog system then uses the results obtained from the discovery and harvesting processes to build or generate catalog information (referred to as a data catalog) for the enterprise. The data catalog for an enterprise provides a single, unified, all-encompassing and searchable view of the datasets of that enterprise.

In certain implementations, a data catalog system may be provided by a cloud service provider and the functionalities provided by a data catalog system are offered as cloud services to subscribing customers, which may be enterprises. Customers subscribing to the data catalog-related services provided by the cloud service provider can then avail themselves of the functionalities provided by a data catalog system. The data cataloging service provides an organized inventory of enterprise data assets that may be stored in various environments including on-premise, cloud, and other environments.

A data catalog generated by a data catalog system for a set of original datasets may include information that reflects the metadata associated with the original datasets. The metadata may include various different types of metadata such technical metadata, business metadata, operational metadata, and other types of metadata. By including information reflecting the metadata of the original datasets in the data catalog, the metadata information is made searchable. For example, users may use the data catalog to search for original datasets meeting a certain criterion (or criteria) (e.g., to find tables containing a particular column attribute, to find datasets where the usage of the datasets is above some threshold, to find datasets having a certain threshold number of records, etc.). The data catalog may then further be used to access the datasets returned as search results in response to search queries specific by the user.

In some instances, a data catalog system may generate a single data catalog for a customer, wherein the single data catalog stores information for all the customer's datasets that are cataloged by a data catalog system. In some other instances, a data catalog system may generate multiple data catalogs for a customer, each data catalog containing information comprising information for a subset of the customer's original datasets.

In certain implementations, the information stored in a data catalog may include information indicative of an original enterprise dataset (or datasets) that was used to generate a synthetic dataset. This way, the synthetic data catalog may include lineage information tracing a line from a synthetic dataset to the original dataset that was used to generate that new dataset. For a synthetic dataset, the synthetic data catalog may also include information that can be used to not only access the synthetic dataset but also the original dataset that was used to generate the synthetic dataset. For example, for a synthetic dataset, a reference or link to the original enterprise dataset used to generate that synthetic dataset may be stored in the synthetic data catalog that contains information for the synthetic dataset. This reference or link enables a user to easily identify the original dataset that was used to generate the new dataset and may enable the user to access that original dataset.

A profiler subsystem of the data catalog may be responsible for profiling the original datasets and the synthetic datasets. The profiler subsystem uses various data profiling techniques to analyze the content, quality and structure of the datasets and provide insights into the data. For example, the profiler subsystem may provide insights into various column and row level statistics, detect patterns, anomalies, and relationships in the data. The profiling may be performed on a continuous basis as new original datasets are cataloged and new synthetic datasets are created. Various different types of profiling may be performed by profiler subsystem 180 including attribute profiling, structural profiling, and schema profiling. Attribute profiling may include profiling information about min/max/average values for a column with numeric datatypes, min/max/average lengths for columns with string data types, mean, median, standard deviation, frequency distribution, distinct counts, nulls, data types, patterns, domains, etc. Structural profiling may determine information about attribute counts (e.g., number of columns in a dataset), row counts, candidate/primary keys, functional dependencies, record classifications, etc. Schema profiling may determine information about overlap analysis (e.g., determine columns that contain the same data), join conditions, primary key-foreign key (PK-FK) relationships discovery, and the like. For example, a data catalog may be utilized to generated profile information for profile access/generation subsystem 130 and/or for storage at training dataset profiles for models 144.

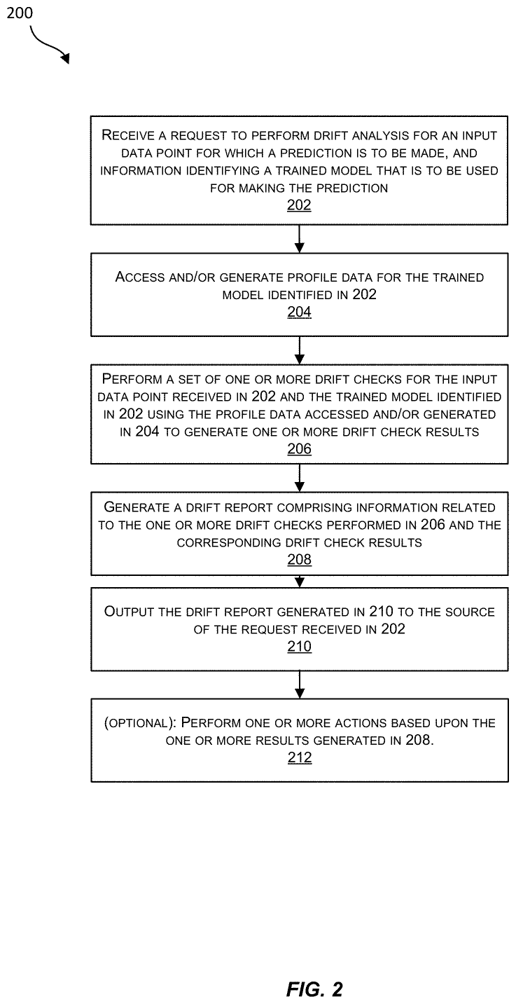

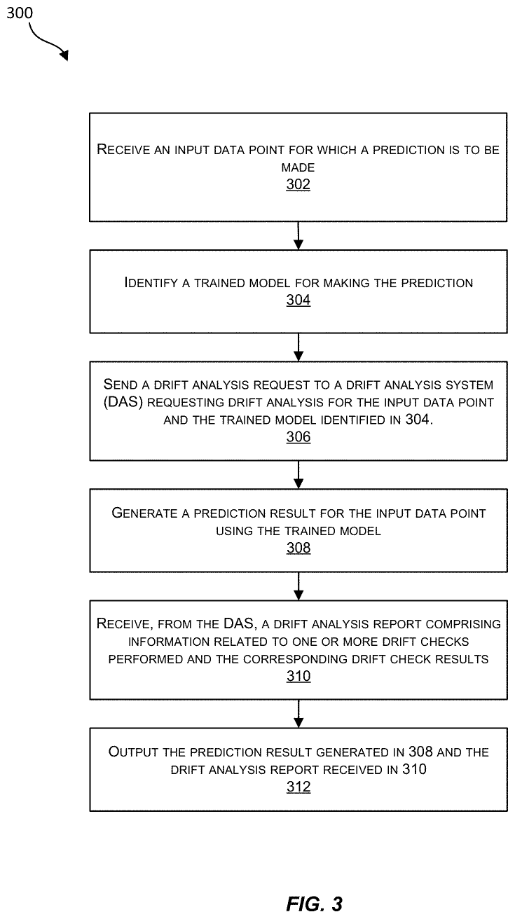

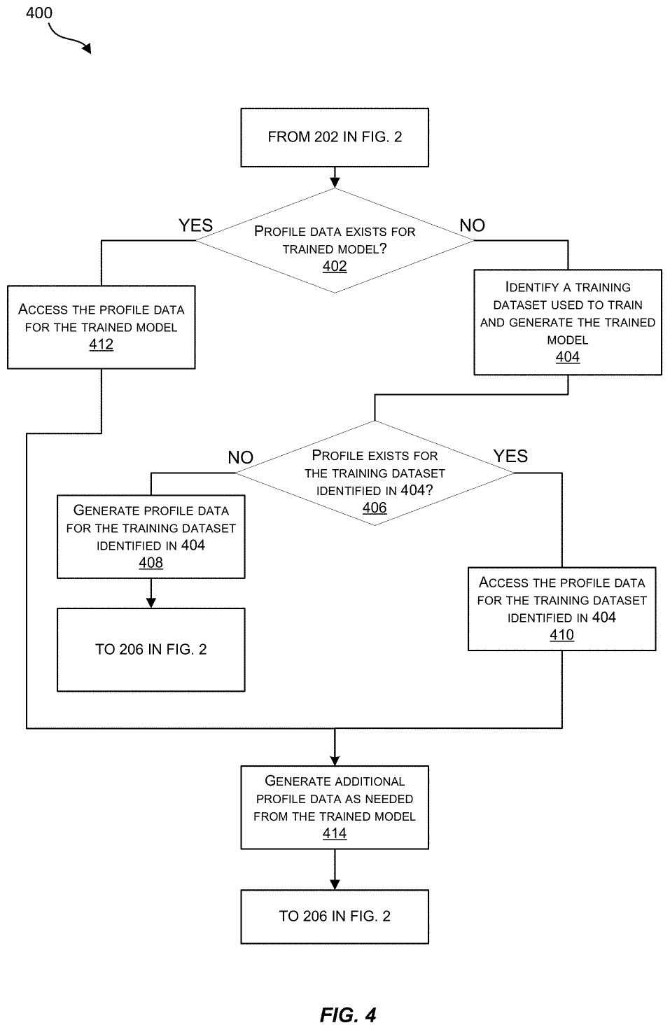

Further details related to processing performed by drift analysis system for generation of the drift report to be served with the prediction data are described below with reference to FIGS. 2, 3, 4, 5, and 6.

FIG. 2 depicts a simplified flow diagram illustrating an example process for generating and outputting, by a drift analysis system, a drift report, according to various embodiments. The processing depicted in FIG. 2 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 2 and described below is intended to be illustrative and non-limiting. Although FIG. 2 depicts the various processing steps occurring in a particular sequence or order, this is not intended to be limiting. In certain alternative embodiments, the processing may be performed in some different order or some steps may also be performed in parallel. In certain embodiments, such as in the embodiment depicted in FIG. 1, the processing depicted in FIG. 2 may be performed by drift analysis system 110.

Process 200 may be initiated at 202, where drift analysis system 110 receives a request to perform drift analysis for an input data point for which a prediction is to be made, and information identifying a trained model that is to be used for making the prediction. The drift analysis request may be received from a prediction service, such as prediction service 100.

At 204, training dataset profile information for the trained model identified in 202 is accessed and/or generated. The training dataset profile information for the trained model identified in 202 may first be identified prior to access and/or generation. For example, the drift analysis system may utilize trained model information identifying the trained model to query a separate dataset. In some embodiments, the queries database contains correspondence information (e.g. mapping data) relating the trained model to some training dataset profile information. In embodiments where no correspondence information exists between the trained model and the training dataset profile information, a correspondence between the trained model and some training dataset(s) used to train the trained model is/are identified. A correspondence between the training dataset(s) and the training dataset profile information is then identified. In some embodiments, in response to determining the correspondence between the training dataset(s) and the training dataset profile information, a correspondence between the training dataset profile information and the trained model is created.

The training data comprises multiple training examples which are used to train an ML model. Each training example includes a training input data point, which is an n-dimensional (n-columns) vector of input values, and a ground truth value corresponding to that training input data point, where the value for “n” is greater than or equal to 1. For example, in the equation y=f(x), “x” is a n-dimensional vector representing the training input data point and “y” is the ground truth value for that input vector. Similarly, the training dataset comprises multiple training input data points, each training input data point comprising a set of columns or dimension and a corresponding ground truth value for each input data point.

In some embodiments, a correspondence between the training dataset profile information and the trained model cannot be found, either directly or indirectly. In this case, training dataset profile information may be generated by processing the training dataset(s) used to train the trained model and generation the training dataset profile information. For example, the training dataset(s) may be parsed to determine some aspects of the training dataset(s) such as the columnar attributes of the training dataset(s), ranges and metrics of values within the training dataset(s), units of measure used by columns of the training dataset(s), etc. The access and/or generation of the training dataset profile information is further detailed in FIG. 4 below.

At 206, a set of one or more drift checks for the input data point received in 202 and the trained model identified in 202 using the training dataset profile information accessed and/or generated in 204 to generate one or more drift check results is performed. Any combination of drift checks may be performed as part of the set of one or more drift checks. In some embodiments, a single drift check, such as an outlier check, is performed. In some embodiments, every check available for performance may be performed as a default drift check process.

In various embodiments, the set of one or more drift checks for the input data point may be performed by a system separate from the drift analysis system, including a serverless function system such as serverless function system 150. For example, the drift analysis system may send the input data point and training dataset profile information over to a networked connection to a separate system to perform the comparisons between the input data point and the training dataset profile information. In some embodiments, a subset of either or both of the input data point and the training dataset profile information may be send to the separate system. For example, the drift analysis system may send only input data values of the input data point and numerical range data of the training dataset profile information to the separate system to perform a numerically based drift check, such as a numerical outlier check.

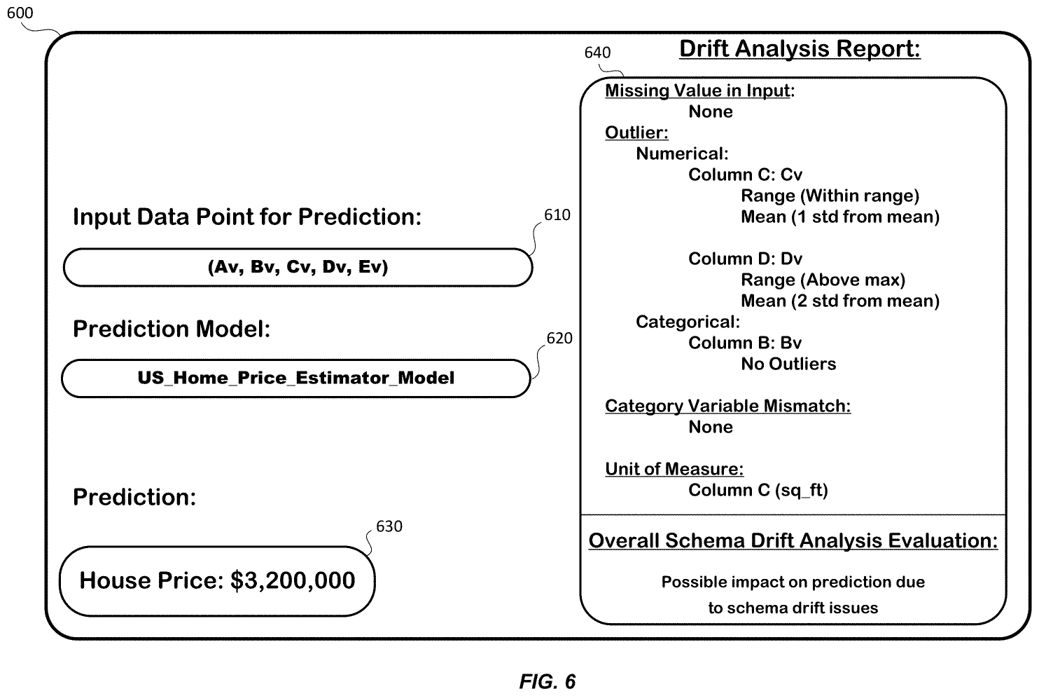

At 208, a drift report comprising information related to the one or more drift checks performed in 206 and the corresponding drift check results is generated. The information related to the one or more drift checks may be sent to the drift analysis system and compiled into a single set of result information. The compiled result information may then be used to generate the drift report. In some embodiments, the drift report is a text report comprising at least some text related to the outcome of the set of one or more drift checks performed in 206. In some embodiments, the drift report is a pictorial report comprising at least some pictorial information related to the outcome of the set of one or more drift checks performed in 206. More examples of a drift report are discussed below, including in FIG. 6.

At 210, the drift report generated in 210 is output to the source of the request received in 202. In embodiments where the request was sent by a prediction service, the drift report is output to the prediction service. The sending of the request and receiving of the drift report by a prediction service are discussed below, including in FIG. 3.

At 212, one or more actions based upon the one or more results generated in 208 may optionally be performed. The one or more actions may be downstream actions based on the drift report or the one or more results generated in 208. The downstream actions may relate to dissemination of the drift report, the one or more results, or some other data related to the analysis of the input data point, including a publishing of collected data to a telemetry system for graphing or logging the data. The downstream actions may relate to some ancillary action to be taken based on the one or more results, such as sending an email that a drift analysis has been performed, updating an input data point or a dataset, retraining a trained model, or altering a prediction result. The downstream action may also relate to improve the processing of the drift analysis system, such as creating new correspondence information between a trained model and training dataset profile information, updating training dataset profile information, or querying a data catalog system for updated aspects of some training dataset profile information. These actions are given as examples and it will be appreciated that many other actions may be taken in block 212.

FIG. 3 depicts a simplified flow diagram illustrating an example process for generating and outputting, by a prediction service, a prediction report and a drift report generated by a drift analysis system, according to various embodiments. The processing depicted in FIG. 3 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 3 and described below is intended to be illustrative and non-limiting. Although FIG. 3 depicts the various processing steps occurring in a particular sequence or order, this is not intended to be limiting. In certain alternative embodiments, the processing may be performed in some different order or some steps may also be performed in parallel. In certain embodiments, such as in the embodiment depicted in FIG. 1, the processing depicted in FIG. 3 may be performed by prediction service 100.

Process 300 may be initiated at 302, where prediction service 100 receives an input data point for which a prediction is to be made. The input data point may be received as part of a request to perform prediction result generation.

At 304, a trained model for making the prediction is identified. In some embodiments, the entity that sent the input data point received in 302 may also specify a trained model for making the prediction. In some embodiments, the prediction service may parse the input data point received in 302 to determine one or more trained models capable of inputting the input data point to the trained model.

At 306, a drift analysis request requesting drift analysis for the input data point and the trained model identified in 304 is sent to a drift analysis system (DAS). The drift analysis system may be drift analysis system 110. The customer or other entity that has requested a prediction result may not specify that a drift analysis should be performed, only that the prediction service generate the prediction. The prediction system may then determine to send the input data point to a DAS to perform drift analysis concurrent with fulfillment of the customer's request to generate prediction results.

At 308, a prediction result for the input data point using the trained model is generated. The prediction result may be generated by inputting the input data point received in 302 to the trained model identified in 304 to generate prediction data. For example, the trained model identified in 304 may be a convolutional neural network ML model comprising one or more neural network nodes which can be mapped to the input data point received in 302. The neural network nodes mapped to the input data point may then be utilized to generate prediction results. It will be appreciated that any number or type of trained ML models may be utilized to perform the prediction.

At 310, a drift analysis report comprising information related to one or more drift checks performed and the corresponding drift check results is received from the DAS. The drift analysis report may be received from the DAS, for example in a manner similar to step 210 of process 200 depicted in FIG. 2.

At 312, the prediction result generated in 308 and the drift analysis report received in 310 are output. The output may be a combined prediction result and drift analysis report that may be output together. The output may be sent to an entity that sent the input data point received in step 302.

FIG. 4 depicts a simplified flow diagram illustrating an example decision flow for retrieving training dataset profile information, according to various embodiments. The processing depicted in FIG. 4 may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIG. 4 and described below is intended to be illustrative and non-limiting. Although FIG. 4 depicts the various processing steps occurring in a particular sequence or order, this is not intended to be limiting. In certain alternative embodiments, the processing may be performed in some different order or some steps may also be performed in parallel.

Process 400 may be initiated after block 202 in FIG. 2. At 402, a determination is made as to whether training dataset profile information exists for a trained model. For example, information related to the trained model may be used to query for correspondence information between the trained model an training dataset profile information. For example, a database may contain mapping data related to a correspondence between the trained model and training dataset profile information previously generated for the trained model. The database may be queried to determine if some mapping data between the trained model and the training dataset profile information exists.

If training dataset profile information exists for the trained model, the process 400 proceeds to 412, where the training dataset profile information for the trained model is accessed. Accessing the training dataset profile information may comprise determining a location that the training dataset profile information is stored in a computer memory and generating a request for the training dataset profile information. The training dataset profile information may then be sent to the requesting entity.

If training dataset profile information does not exists for a trained model, the process 400 proceeds to 404, where a training dataset used to train and generate the trained model is identified. For example, information related to the trained model may be used to query for correspondence information between the trained model some training dataset(s) used to train the trained model.

At 406, a determination is made as to whether a profile exists for the training dataset identified in 404. For example, once the training dataset is identified in 404, a query may be generated for information related to a correspondence between the training dataset(s) and the training dataset profile information. For example, a database may contain mapping data related to a correspondence between the trained model and the training dataset(s).

If no profile exists for the training dataset identified in 404, the process 400 proceeds to 408, where training dataset profile information for the training dataset identified in 404 is generated. Generation of the training dataset profile information may comprise determining one or more metrics based on the training dataset(s) and storing those metrics as part of the training dataset profile information. For example, numerical ranges for a column of data in a training dataset may be parsed to determine metrics, such as min value, max value, median value, mean value, etc. The process 400 may then proceed to block 206 in process 200 of FIG. 2.

If a profile exists for the training dataset identified in 404, the process 400 proceeds to 410, where the training dataset profile information for the training dataset identified in 404 is accessed. Following the access of the training dataset profile information for the trained model in 412 or the access of the training dataset profile information for the training dataset identified in 404 in block 410, the process 400 proceeds to 414, where additional training dataset profile information as needed is generated for the trained model. For example, a data catalog may be queried for updated information related to the training dataset(s). Any updated information may be further incorporated into the training dataset profile information The process 400 may then proceed to block 206 in process 200 of FIG. 2.

FIGS. 5A and 5B depict a simplified flow diagram illustrating an example process for performing a set of checks on an input data point based on a profile, according to various embodiments. The processing depicted in FIGS. 5A and 5B may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in FIGS. 5A and 5B and described below is intended to be illustrative and non-limiting. Although FIGS. 5A and 5B depict the various processing steps occurring in a particular sequence or order, this is not intended to be limiting. In certain alternative embodiments, the processing may be performed in some different order or some steps may also be performed in parallel.

Process 500 depicted in FIG. 5A is an example process for performing a series of drift checks on an input data point using training dataset profile information/training dataset(s). It will be appreciated that process 500 may include other drift checks and other configurations. Process 500 may be initiated at 510, where a missing value detection check is performed. The missing value detection check may be performed by parsing all, or a subset of, the input data point to determine if one or more values are not present in the data point. For example, a function may parse the input data point to determine a number of null or non-existent values in the input data point. In some embodiments, a drift check result of the missing value detection check comprising a number or percentage of input data values in the input data point that are missing.

A missing value detection check at 510 may include a determination that a particular value of an input data point is not “missing.” A “missing” value may be a value that is non-existent, null, default, incompatible, and/or otherwise non-compliant with aspects of the input data point/dataset. In one example, an input data point contains five data fields which may be populated by up to five field values. Data for first, second, fourth, and fifth data field values may be found for the input data point, but data for a third data field value may not be present, or may be represented by a null value. At 510, it would be determined that the input data point contains a missing value corresponding to the missing third data field value. In another example, the third data field value is present, but is represented by computer code that is not readable by a drift analysis system. The value will also be regarded as a missing value for the purposes of determining schema drift.

At 520, an outlier check is performed. The outlier check in 520 may comprise multiple sub-steps for performing the check. One set of sub-steps may comprise performing an outlier check for numerically based input data values of the input data point. For example, at 521, any numerical columns of the training dataset are identified. In some embodiments, the training dataset profile information is used to identify the numerical columns of the training dataset.

At 522, for each numerical column identified in 521, characteristic values (min, max, average, median, etc.) for the numerical column are determined from the training dataset profile information. For example, for each numerical column identified in 521, a corresponding portion of the training dataset profile information may be identified. The corresponding portion of the training dataset profile information may contain the characteristic values that were previously generated for the training dataset profile information. For example, characteristic values associated with numerically derived metrics of values in the training dataset may be given in the training dataset profile information. In some embodiments, the characteristic values may be identified and retrieved from a data catalog system.

At 523, each numerical column of the input data point is compared to the range values determined in 522. For example, for each numerical column of the input data point, a corresponding input data value may be identified. Each of the identified corresponding input data values may be compared to one or more characteristic values identified in 522. For example, a numerical input data value of a numerical column of the input data point may be compared to one or more of the characteristic values identified in step 522. In some embodiments, the input data values are compared to a range formed by a min and max characteristic value. In some embodiments, the input data values are compared to a distribution of characteristic values formed by the mean and standard deviation of the characteristic values in the training dataset(s).

A numerical column comparison at 523 may include a determination that a particular value of an input data point is outside of numerical range values determined in 522. For example, for a particular numerical column identified in 521, characteristic values of “200,” “1000,” “700,” and “600” are determined corresponding to minimum, maximum, average, and median values, respectively. An input data point containing an input value of “300” corresponding to the same numerical column would be determined to pass the outlier check (“300” is inside the range of “200” to “1000”). Another input data point containing an input value of “2” corresponding to the same numerical column would be determined to fail the outlier check (“2” is not inside the range of “200” to “1000”). Furthermore, the outlier check performed in 520 may determine a standard deviation that the value of the input data point falls outside of the range. In some embodiments, a subset of the input data point is sent to a function performing the outlier check. For example, only input data values of numerical columns may be sent to an outlier check function to simplify the comparisons in the outlier check 520.

Prior to, subsequent to, or concurrently with 521, at 524, any categorical columns of the training dataset are identified. In some embodiments, the training dataset profile information is used to identify the categorical columns of the training dataset.

At 525, for each categorical column, the different unique category values in the training dataset for that column are determined. For example, for each categorical column identified in 524, a corresponding portion of the training dataset profile information may be identified. The corresponding portion of the training dataset profile information may contain the category values that were previously generated for the training dataset profile information. For example, category values associated with categorical values in the training dataset may compiled to form a category set of values. In some embodiments, the characteristic values may be identified and retrieved from a data catalog system.

At 526, for each categorical column identified in 524, the corresponding value in the input data point is compared to the categorical values determined in 525. For each, each categorical value of the input data point may be compared to the category set of values from the training dataset to determine if the categorical values of the input data point is within the category set of values. A drift check result of 520 may comprise information identifying values which are outliers compared to the training data characteristics and category values and may also identify a relative difference between the input data values and the training dataset-derived values. The process 500 may then proceed to 530.

A categorical column comparison at 526 may include a determination that a particular value of an input data point is or is not included in a range of categorical values determined in 525. For example, for a particular categorical column identified in 524, characteristic values of “San Francisco,” “Los Angeles,” and “Sacramento” may be the exhaustive list of unique category values. An input data point containing an input value of “San Francisco” corresponding to the same particular categorical column would be determined to pass the outlier check because the value “San Francisco” is one of the unique category values. Another input data point containing an input value of “Cincinnati” corresponding to the same particular categorical column would be determined to fail the outlier check, because “Cincinnati” is not one of the unique category values determined in 525 for that particular categorical column.

Process 500 depicted in FIG. 5B may continue at 530, where a category mismatch check is performed. The category mismatch check may comprise sub-steps for performing the check. For example, at 532, for each column in the training dataset, the column category label is determined. In some embodiments, the training dataset profile information is used to identify the column category labels of the training dataset.

At 534, for each column identified in 532, each corresponding column label in the input data point is compared the column labels identified in 532 to identify any column category label mismatches. In some embodiments, a type of label category is a mismatch, such as an integer versus a string. In some embodiments, the content of a label category is a mismatch, for example two strings that comprise different sequences of characters. The output of 530 may be one or more drift check results identifying category columns of the input data point that do not match corresponding category columns of the training dataset(s).

A category mismatch comparison at 534 may include a determination that each particular label of a set of labels in the input data point does or does match a corresponding column category label determined in 532. The category labels of the input data point will only pass the check if each label categories match the label categories determined in 532 in both category and position. In one example, column category labels determined in 532 correspond to category labels in the following order: a first category label of “NAME,” a second category label of “JOB,” and a third category label of “NEIGHBORHOOD.” An example input data point contains category labels in the following order: a first category label of “NAME,” a second category label of “NEIGHBORHOOD,” and a third category label of “MARITAL_STATUS”. At 534 it would be determined that the first category label of the input data point is valid (a first label of “NAME” matches a first label of “NAME”). It would further be determined that the second category label of the input data point is invalid (a second label of the input data of “NEIGHBORHOOD,” does not match the second label category determined in 532 of “JOB,” even though the label categories determined in 532 contain a “NEIGHBORHOOD” category label as the third category label). It would further be determined that the third category label of the input data point is invalid (a third label of the input data of “MARITAL_STATUS” does not match the third label category determined in 532 of “NEIGHBORHOOD”).

At 540, a unit of measure check is performed. the unit of measure check may comprise sub-steps for performing the check. For example, at 542, for each column in the training data characterized by a unit of measure, the unit of measure is determined. In some embodiments, the training dataset profile information is used to identify the units of measure for the columns of the training dataset.

At 544, for each column identified in 542, the corresponding column in the input data point is compared to the column identified in 542 to identify any unit of measure mismatches. In some embodiments, a unit of measure is a mismatch if a character of set of character corresponding to the unit of measure in the input data value does not match a corresponding character of set of characters of a column of the training data. The output of 540 may be one or more drift check results identifying units of measure of columns of the input data point that do not match corresponding units of measure of columns of the training dataset(s).

A unit of measure comparison at 544 may include a determination that each particular unit of measure of a set of units of measure in the input data point does or does match a corresponding unit of measure of a corresponding column as determined in 542. The columns of the input data point will only pass the check if the unit of measure in the particular column matches the unit of measure of the corresponding column unit of measure determined in 542. In one example, units of measure determined in 542 correspond to units of measure in the following order: a first column corresponding to units of measure of U.S. Dollars (“$”) and a second column corresponding to a string values with no units of measure. An example input data point contains units of measure in the following order: a first columnar value with a unit of measure label of Japanese Yen (Y) and a second columnar value with a unit of measure label of meters-per-second (m/s). At 534 it would be determined that the first unit of measure of the input data point is invalid (a unit of measure of Japanese Yen does not correspond to a unit of measure of U.S. Dollars). It would further be determined that the second unit of measure of the input data point is invalid (a unit of measure was found for the input data point in the second column despite no unit of measure being correlated with the second columnar unit of measure determined in 542).

In some embodiments, the outcome of process 500 may be the set of one or more drift check results as described herein as derived from each of the checks 510, 520, 530, and 540.

FIG. 6 depicts an example user interface for outputting information about a prediction made using an ML model along with a drift analysis report and prediction report, according to various embodiments. As depicted in FIG. 6, an interface 600 may be presented to an entity, such as a customer of a prediction service.

Interface 600 outputs information 610 about the input data point for which a prediction is made, the ML model 620 used for making the prediction, the prediction 630, and information 640 included in a drift analysis report generated by the drift analysis system. For example, as depicted in FIG. 6, information 610 is output regarding an input data point “(Aᵥ, Bᵥ, Cᵥ, Dᵥ, Eᵥ)” that was provided as input and for which a prediction was made. In the example depicted in FIG. 6, the input data point contains values for six dimensions/columns. The values in the input are: “Aᵥ,” “Bᵥ,” “Cᵥ,” “Dᵥ,” and “Eᵥ” representing an input data point where the dimension/column are columnar attributes of A, B, C, D, and E, and the particular values of the input data points are “Aᵥ,” “Bᵥ,” “Cᵥ,” “Dᵥ,” and “Eᵥ”.

For example, the input shown in FIG. 6 may correspond to an input for predicting the price of a home in a particular area. For example, Aᵥ may be “95014” corresponding to a categorical zip code value, By may be “$200,000” corresponding to a numerical average income in the zip code having an associated unit of measure of “$,” Cᵥ may be “2400” corresponding to a numerical square footage of a house with an associated unit of measure of “square-Feet,” Dᵥ is “6” corresponding to a numerical value of a number of rooms in the house, and Eᵥ is “3” corresponding to a numerical value of a number of bathrooms in the house.

Interface 600 also depicts information 620 indicative of a ML model used to make a price prediction for the input. For example, as depicted in FIG. 6, a trained ML model called “US_Home_Price_Estimator_Model” is selected for making the price prediction.

Interface 600 may further comprise a prediction display field 630 displaying a prediction result generated for the input identified in 610 and where the prediction is made using the trained ML model identified in 620. For example, as depicted in FIG. 6, a house price prediction of “$3,200,000” is made for house and area indicated in the input.

In the embodiment depicted in FIG. 6, interface 600 outputs drift analysis report 640 generated for the input indicated in 610 and the model identified by 620 that was used to make the prediction. As shown in FIG. 6, report 640 outputs information regarding various drift check that were performed and the results of those checks. In the example depicted in FIG. 6, the information that is output in the drift analysis report indicates that the following checks were performed: missing value input check; outliers checks both for numerical columns and categorical columns, category variable mismatch checks, and unit of measure checks. For each check, the results of the check are also shown.

For example, for the missing value in input check, the result information indicates that there was no missing value. The report indicates that the input and the training dataset included two columns/dimensions, namely, columns C and D, containing numerical values, and one column, namely column B, containing categorical values. Outliers checks were performed for these columns.

For example, for numerical columns C and D, a range check was performed to see if the values for these columns in the input (i.e., Cᵥ and Dᵥ) are within the range of the values for those columns in the training dataset for model “US_Home_Price_Estimator_Model.” As shown in FIG. 6, an outlier check generated a warning for column D, where value Dᵥ was determined to be above the max value for column D in the training dataset. For example, the value of D, in the input is 6 rooms but the maximum value for corresponding column D in the training dataset is less than six (e.g., is 5) thus resulting in Dᵥ being out of range.

Also, for the numerical columns, a check was performed to see how the value for those columns in the input compared to the mean for those columns in the training dataset. As shown in FIG. 6, Cᵥ in the input was determined to be one standard deviation from the mean for that column in the training dataset, and D, in the input was determined to be two standard deviations from the mean for column D in the training dataset.

For the category variable mismatch, the results indicated in FIG. 6 indicate that no category mismatch was found. For example, Aᵥ, which is “95014,” is a zipcode value that corresponds to the categorical zip code value. Bᵥ, which is “$200,000,” is a numerical average income value corresponding to a numerical average income in the zip code. Cᵥ, which is “2400,” is a numerical square footage value corresponding to a numerical square footage of a house unit. Dᵥ, which is “6,” is a numerical value corresponding to a numerical value of a number of rooms in the house. Eᵥ, which is “3,” is a numerical number corresponding to a numerical value of a number of bathrooms in the house. Therefore, there is no category mismatch between the values of the input data point and the categories variables.

For the units of measure check, it was determined that there was a unit of measure mismatch between value Cᵥ in the input and the unit of measure in corresponding column C in the training dataset. For example, the unit of measure in the training dataset for column C may be “square-Meters” but instead Cᵥ in the input is provided in “square-Feet” resulting in a unit of measure mismatch.

In the example depicted in FIG. 6, an overall schema drift evaluation is also provided. This overall evaluation is based upon the results from the various drift checks performed by the drift analysis system. As shown in FIG. 6, the overall evaluation provides a warning to the user indicating that the prediction (in 630) may potentially not be accurate due to schema drift issues identified in drift analysis report 640.

In certain embodiments, the drift analysis system, prediction service, serverless function system, of any combination of the above may be provided as cloud services by a cloud services provider. For example, a cloud services provider may provide Infrastructure-as-a-Service (IaaS) services that provide computing, memory, and networking resources that can be used to host or implement the prediction system and/or the drift analysis system. These services may be subscribed to by one or more customers. A customer may also use the infrastructure resources provided by the IaaS services provider to run their compute loads (e.g., applications, virtual machines, containers, etc.). The IaaS provider may also provide other cloud services to its customers. An example IaaS architecture/infrastructure capable of hosting or providing the prediction and drift analysis services described herein is described below.

### Example Infrastructure-as-a-Service Implementation

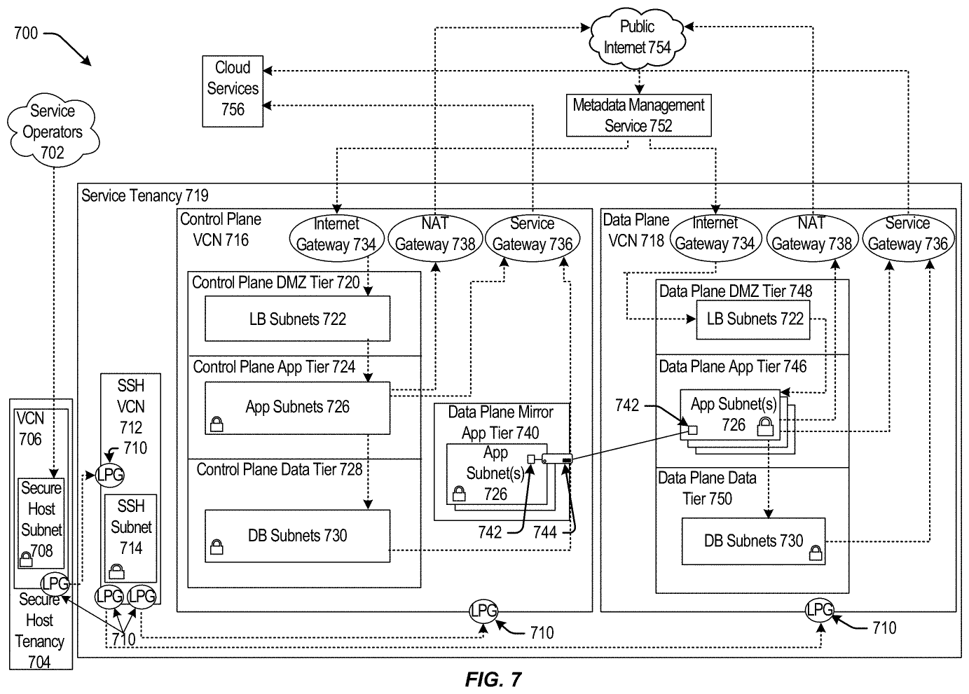

FIG. 7 depicts a drift analysis system for determining and reporting schema drift for predictions according to various embodiments. As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, security, load balancing and clustering, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different problems for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more security group rules provisioned to define how the security of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 7 is a block diagram 700 illustrating an example pattern of an IaaS architecture, according to at least one embodiment. Service operators 702 can be communicatively coupled to a secure host tenancy 704 that can include a virtual cloud network (VCN) 706 and a secure host subnet 708. In some examples, the service operators 702 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 706 and/or the Internet.

The VCN 706 can include a local peering gateway (LPG) 710 that can be communicatively coupled to a secure shell (SSH) VCN 712 via an LPG 710 contained in the SSH VCN 712. The SSH VCN 712 can include an SSH subnet 714, and the SSH VCN 712 can be communicatively coupled to a control plane VCN 716 via the LPG 710 contained in the control plane VCN 716. Also, the SSH VCN 712 can be communicatively coupled to a data plane VCN 718 via an LPG 710. The control plane VCN 716 and the data plane VCN 718 can be contained in a service tenancy 719 that can be owned and/or operated by the IaaS provider.

The control plane VCN 716 can include a control plane demilitarized zone (DMZ) tier 720 that acts as a perimeter network (e.g., portions of a corporate network between the corporate intranet and external networks). The DMZ-based servers may have restricted responsibilities and help keep security breaches contained. Additionally, the DMZ tier 720 can include one or more load balancer (LB) subnet(s) 722, a control plane app tier 724 that can include app subnet(s) 726, a control plane data tier 728 that can include database (DB) subnet(s) 730 (e.g., frontend DB subnet(s) and/or backend DB subnet(s)). The LB subnet(s) 722 contained in the control plane DMZ tier 720 can be communicatively coupled to the app subnet(s) 726 contained in the control plane app tier 724 and an Internet gateway 734 that can be contained in the control plane VCN 716, and the app subnet(s) 726 can be communicatively coupled to the DB subnet(s) 730 contained in the control plane data tier 728 and a service gateway 736 and a network address translation (NAT) gateway 738. The control plane VCN 716 can include the service gateway 736 and the NAT gateway 738.

The control plane VCN 716 can include a data plane mirror app tier 740 that can include app subnet(s) 726. The app subnet(s) 726 contained in the data plane mirror app tier 740 can include a virtual network interface controller (VNIC) 742 that can execute a compute instance 744. The compute instance 744 can communicatively couple the app subnet(s) 726 of the data plane mirror app tier 740 to app subnet(s) 726 that can be contained in a data plane app tier 746.

The data plane VCN 718 can include the data plane app tier 746, a data plane DMZ tier 748, and a data plane data tier 750. The data plane DMZ tier 748 can include LB subnet(s) 722 that can be communicatively coupled to the app subnet(s) 726 of the data plane app tier 746 and the Internet gateway 734 of the data plane VCN 718. The app subnet(s) 726 can be communicatively coupled to the service gateway 736 of the data plane VCN 718 and the NAT gateway 738 of the data plane VCN 718. The data plane data tier 750 can also include the DB subnet(s) 730 that can be communicatively coupled to the app subnet(s) 726 of the data plane app tier 746.

The Internet gateway 734 of the control plane VCN 716 and of the data plane VCN 718 can be communicatively coupled to a metadata management service 752 that can be communicatively coupled to public Internet 754. Public Internet 754 can be communicatively coupled to the NAT gateway 738 of the control plane VCN 716 and of the data plane VCN 718. The service gateway 736 of the control plane VCN 716 and of the data plane VCN 718 can be communicatively coupled to cloud services 756.

In some examples, the service gateway 736 of the control plane VCN 716 or of the data plane VCN 718 can make application programming interface (API) calls to cloud services 756 without going through public Internet 754. The API calls to cloud services 756 from the service gateway 736 can be one-way: the service gateway 736 can make API calls to cloud services 756, and cloud services 756 can send requested data to the service gateway 736. But, cloud services 756 may not initiate API calls to the service gateway 736.

In some examples, the secure host tenancy 704 can be directly connected to the service tenancy 719, which may be otherwise isolated. The secure host subnet 708 can communicate with the SSH subnet 714 through an LPG 710 that may enable two-way communication over an otherwise isolated system. Connecting the secure host subnet 708 to the SSH subnet 714 may give the secure host subnet 708 access to other entities within the service tenancy 719.

The control plane VCN 716 may allow users of the service tenancy 719 to set up or otherwise provision desired resources. Desired resources provisioned in the control plane VCN 716 may be deployed or otherwise used in the data plane VCN 718. In some examples, the control plane VCN 716 can be isolated from the data plane VCN 718, and the data plane mirror app tier 740 of the control plane VCN 716 can communicate with the data plane app tier 746 of the data plane VCN 718 via VNICs 742 that can be contained in the data plane mirror app tier 740 and the data plane app tier 746.

In some examples, users of the system, or customers, can make requests, for example create, read, update, or delete (CRUD) operations, through public Internet 754 that can communicate the requests to the metadata management service 752. The metadata management service 752 can communicate the request to the control plane VCN 716 through the Internet gateway 734. The request can be received by the LB subnet(s) 722 contained in the control plane DMZ tier 720. The LB subnet(s) 722 may determine that the request is valid, and in response to this determination, the LB subnet(s) 722 can transmit the request to app subnet(s) 726 contained in the control plane app tier 724. If the request is validated and requires a call to public Internet 754, the call to public Internet 754 may be transmitted to the NAT gateway 738 that can make the call to public Internet 754. Memory that may be desired to be stored by the request can be stored in the DB subnet(s) 730.

In some examples, the data plane mirror app tier 740 can facilitate direct communication between the control plane VCN 716 and the data plane VCN 718. For example, changes, updates, or other suitable modifications to configuration may be desired to be applied to the resources contained in the data plane VCN 718. Via a VNIC 742, the control plane VCN 716 can directly communicate with, and can thereby execute the changes, updates, or other suitable modifications to configuration to, resources contained in the data plane VCN 718.

In some embodiments, the control plane VCN 716 and the data plane VCN 718 can be contained in the service tenancy 719. In this case, the user, or the customer, of the system may not own or operate either the control plane VCN 716 or the data plane VCN 718. Instead, the IaaS provider may own or operate the control plane VCN 716 and the data plane VCN 718, both of which may be contained in the service tenancy 719. This embodiment can enable isolation of networks that may prevent users or customers from interacting with other users', or other customers', resources. Also, this embodiment may allow users or customers of the system to store databases privately without needing to rely on public Internet 754, which may not have a desired level of security, for storage.

In other embodiments, the LB subnet(s) 722 contained in the control plane VCN 716 can be configured to receive a signal from the service gateway 736. In this embodiment, the control plane VCN 716 and the data plane VCN 718 may be configured to be called by a customer of the IaaS provider without calling public Internet 754. Customers of the IaaS provider may desire this embodiment since database(s) that the customers use may be controlled by the IaaS provider and may be stored on the service tenancy 719, which may be isolated from public Internet 754.

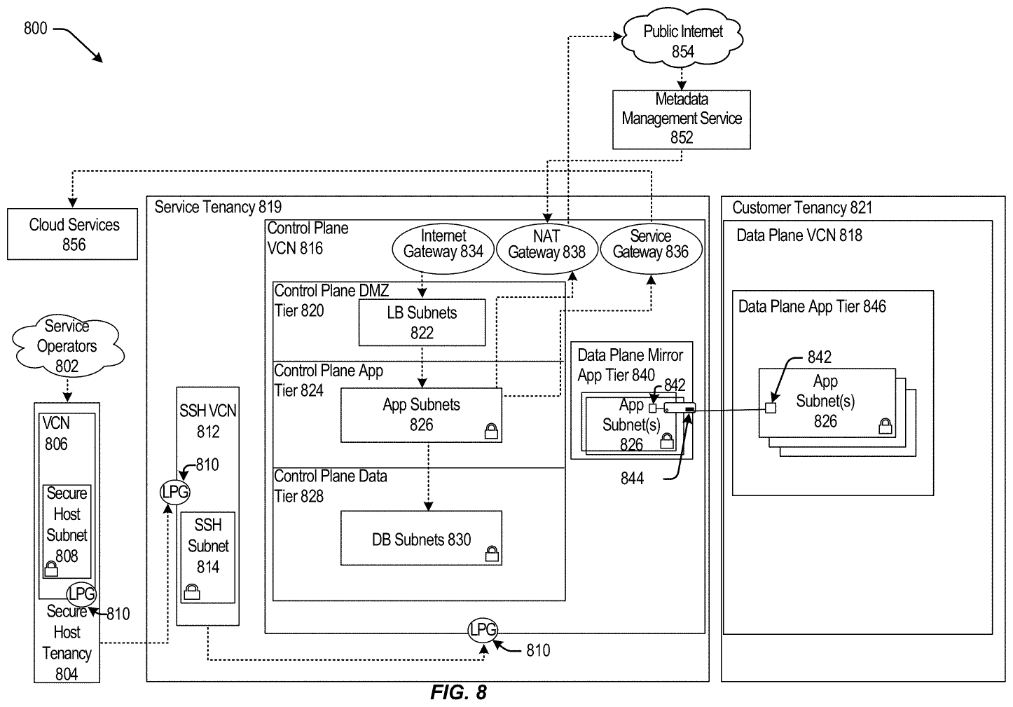

FIG. 8 is a block diagram 800 illustrating another example pattern of an IaaS architecture, according to at least one embodiment. Service operators 802 (e.g. service operators 702 of FIG. 7) can be communicatively coupled to a secure host tenancy 804 (e.g. the secure host tenancy 704 of FIG. 7) that can include a virtual cloud network (VCN) 806 (e.g. the VCN 706 of FIG. 7) and a secure host subnet 808 (e.g. the secure host subnet 708 of FIG. 7). The VCN 806 can include a local peering gateway (LPG) 810 (e.g. the LPG 710 of FIG. 7) that can be communicatively coupled to a secure shell (SSH) VCN 812 (e.g. the SSH VCN 712 of FIG. 7) via an LPG 710 contained in the SSH VCN 812. The SSH VCN 812 can include an SSH subnet 814 (e.g. the SSH subnet 714 of FIG. 7), and the SSH VCN 812 can be communicatively coupled to a control plane VCN 816 (e.g. the control plane VCN 716 of FIG. 7) via an LPG 810 contained in the control plane VCN 816. The control plane VCN 816 can be contained in a service tenancy 819 (e.g. the service tenancy 719 of FIG. 7), and the data plane VCN 818 (e.g. the data plane VCN 718 of FIG. 7) can be contained in a customer tenancy 821 that may be owned or operated by users, or customers, of the system.

The control plane VCN 816 can include a control plane DMZ tier 820 (e.g. the control plane DMZ tier 720 of FIG. 7) that can include LB subnet(s) 822 (e.g. LB subnet(s) 722 of FIG. 7), a control plane app tier 824 (e.g. the control plane app tier 724 of FIG. 7) that can include app subnet(s) 826 (e.g. app subnet(s) 726 of FIG. 7), a control plane data tier 828 (e.g. the control plane data tier 728 of FIG. 7) that can include database (DB) subnet(s) 830 (e.g. similar to DB subnet(s) 730 of FIG. 7). The LB subnet(s) 822 contained in the control plane DMZ tier 820 can be communicatively coupled to the app subnet(s) 826 contained in the control plane app tier 824 and an Internet gateway 834 (e.g. the Internet gateway 734 of FIG. 7) that can be contained in the control plane VCN 816, and the app subnet(s) 826 can be communicatively coupled to the DB subnet(s) 830 contained in the control plane data tier 828 and a service gateway 836 (e.g. the service gateway of FIG. 7) and a network address translation (NAT) gateway 838 (e.g. the NAT gateway 738 of FIG. 7). The control plane VCN 816 can include the service gateway 836 and the NAT gateway 838.

The control plane VCN 816 can include a data plane mirror app tier 840 (e.g. the data plane mirror app tier 740 of FIG. 7) that can include app subnet(s) 826. The app subnet(s) 826 contained in the data plane mirror app tier 840 can include a virtual network interface controller (VNIC) 842 (e.g. the VNIC of 742) that can execute a compute instance 844 (e.g. similar to the compute instance 744 of FIG. 7). The compute instance 844 can facilitate communication between the app subnet(s) 826 of the data plane mirror app tier 840 and the app subnet(s) 826 that can be contained in a data plane app tier 846 (e.g. the data plane app tier 746 of FIG. 7) via the VNIC 842 contained in the data plane mirror app tier 840 and the VNIC 842 contained in the data plane app tier 846.

The Internet gateway 834 contained in the control plane VCN 816 can be communicatively coupled to a metadata management service 852 (e.g. the metadata management service 752 of FIG. 7) that can be communicatively coupled to public Internet 854 (e.g. public Internet 754 of FIG. 7). Public Internet 854 can be communicatively coupled to the NAT gateway 838 contained in the control plane VCN 816. The service gateway 836 contained in the control plane VCN 816 can be communicatively couple to cloud services 856 (e.g. cloud services 756 of FIG. 7).

In some examples, the data plane VCN 818 can be contained in the customer tenancy 821. In this case, the IaaS provider may provide the control plane VCN 816 for each customer, and the IaaS provider may, for each customer, set up a unique compute instance 844 that is contained in the service tenancy 819. Each compute instance 844 may allow communication between the control plane VCN 816, contained in the service tenancy 819, and the data plane VCN 818 that is contained in the customer tenancy 821. The compute instance 844 may allow resources, that are provisioned in the control plane VCN 816 that is contained in the service tenancy 819, to be deployed or otherwise used in the data plane VCN 818 that is contained in the customer tenancy 821.

In other examples, the customer of the IaaS provider may have databases that live in the customer tenancy 821. In this example, the control plane VCN 816 can include the data plane mirror app tier 840 that can include app subnet(s) 826. The data plane mirror app tier 840 can reside in the data plane VCN 818, but the data plane mirror app tier 840 may not live in the data plane VCN 818. That is, the data plane mirror app tier 840 may have access to the customer tenancy 821, but the data plane mirror app tier 840 may not exist in the data plane VCN 818 or be owned or operated by the customer of the IaaS provider. The data plane mirror app tier 840 may be configured to make calls to the data plane VCN 818, but may not be configured to make calls to any entity contained in the control plane VCN 816. The customer may desire to deploy or otherwise use resources in the data plane VCN 818 that are provisioned in the control plane VCN 816, and the data plane mirror app tier 840 can facilitate the desired deployment, or other usage of resources, of the customer.

In some embodiments, the customer of the IaaS provider can apply filters to the data plane VCN 818. In this embodiment, the customer can determine what the data plane VCN 818 can access, and the customer may restrict access to public Internet 854 from the data plane VCN 818. The IaaS provider may not be able to apply filters or otherwise control access of the data plane VCN 818 to any outside networks or databases. Applying filters and controls by the customer onto the data plane VCN 818, contained in the customer tenancy 821, can help isolate the data plane VCN 818 from other customers and from public Internet 854.

In some embodiments, cloud services 856 can be called by the service gateway 836 to access services that may not exist on public Internet 854, on the control plane VCN 816, or on the data plane VCN 818. The connection between cloud services 856 and the control plane VCN 816 or the data plane VCN 818 may not be live or continuous. Cloud services 856 may exist on a different network owned or operated by the IaaS provider. Cloud services 856 may be configured to receive calls from the service gateway 836 and may be configured to not receive calls from public Internet 854. Some cloud services 856 may be isolated from other cloud services 856, and the control plane VCN 816 may be isolated from cloud services 856 that may not be in the same region as the control plane VCN 816. For example, the control plane VCN 816 may be located in “Region 1,” and cloud service “Deployment 8,” may be located in Region 1 and in “Region 2.” If a call to Deployment 8 is made by the service gateway 836 contained in the control plane VCN 816 located in Region 1, the call may be transmitted to Deployment 8 in Region 1. In this example, the control plane VCN 816, or Deployment 8 in Region 1, may not be communicatively coupled to, or otherwise in communication with, Deployment 8 in Region 2.

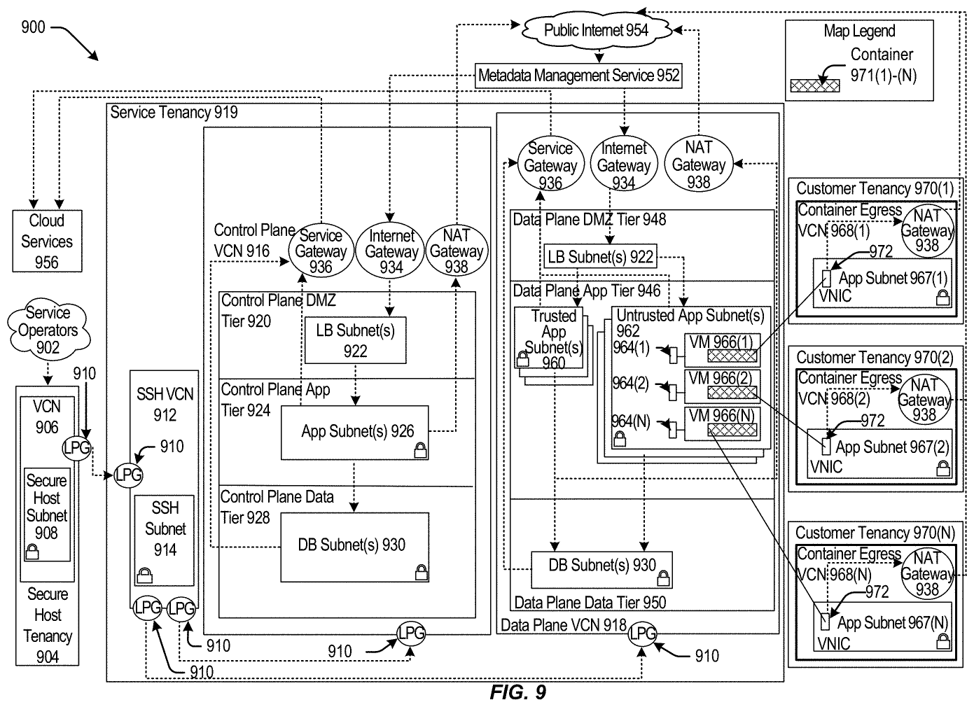

FIG. 9 is a block diagram 900 illustrating another example pattern of an IaaS architecture, according to at least one embodiment. Service operators 902 (e.g. service operators 702 of FIG. 7) can be communicatively coupled to a secure host tenancy 904 (e.g. the secure host tenancy 704 of FIG. 7) that can include a virtual cloud network (VCN) 906 (e.g. the VCN 706 of FIG. 7) and a secure host subnet 908 (e.g. the secure host subnet 708 of FIG. 7). The VCN 906 can include an LPG 910 (e.g. the LPG 710 of FIG. 7) that can be communicatively coupled to an SSH VCN 912 (e.g. the SSH VCN 712 of FIG. 7) via an LPG 910 contained in the SSH VCN 912. The SSH VCN 912 can include an SSH subnet 914 (e.g. the SSH subnet 714 of FIG. 7), and the SSH VCN 912 can be communicatively coupled to a control plane VCN 916 (e.g. the control plane VCN 716 of FIG. 7) via an LPG 910 contained in the control plane VCN 916 and to a data plane VCN 918 (e.g. the data plane 718 of FIG. 7) via an LPG 910 contained in the data plane VCN 918. The control plane VCN 916 and the data plane VCN 918 can be contained in a service tenancy 919 (e.g. the service tenancy 719 of FIG. 7).

The control plane VCN 916 can include a control plane DMZ tier 920 (e.g. the control plane DMZ tier 720 of FIG. 7) that can include load balancer (LB) subnet(s) 922 (e.g. LB subnet(s) 722 of FIG. 7), a control plane app tier 924 (e.g. the control plane app tier 724 of FIG. 7) that can include app subnet(s) 926 (e.g. similar to app subnet(s) 726 of FIG. 7), a control plane data tier 928 (e.g. the control plane data tier 728 of FIG. 7) that can include DB subnet(s) 930. The LB subnet(s) 922 contained in the control plane DMZ tier 920 can be communicatively coupled to the app subnet(s) 926 contained in the control plane app tier 924 and to an Internet gateway 934 (e.g. the Internet gateway 734 of FIG. 7) that can be contained in the control plane VCN 916, and the app subnet(s) 926 can be communicatively coupled to the DB subnet(s) 930 contained in the control plane data tier 928 and to a service gateway 936 (e.g. the service gateway of FIG. 7) and a network address translation (NAT) gateway 938 (e.g. the NAT gateway 738 of FIG. 7). The control plane VCN 916 can include the service gateway 936 and the NAT gateway 938.

The data plane VCN 918 can include a data plane app tier 946 (e.g. the data plane app tier 746 of FIG. 7), a data plane DMZ tier 948 (e.g. the data plane DMZ tier 748 of FIG. 7), and a data plane data tier 950 (e.g. the data plane data tier 750 of FIG. 7). The data plane DMZ tier 948 can include LB subnet(s) 922 that can be communicatively coupled to trusted app subnet(s) 960 and untrusted app subnet(s) 962 of the data plane app tier 946 and the Internet gateway 934 contained in the data plane VCN 918. The trusted app subnet(s) 960 can be communicatively coupled to the service gateway 936 contained in the data plane VCN 918, the NAT gateway 938 contained in the data plane VCN 918, and DB subnet(s) 930 contained in the data plane data tier 950. The untrusted app subnet(s) 962 can be communicatively coupled to the service gateway 936 contained in the data plane VCN 918 and DB subnet(s) 930 contained in the data plane data tier 950. The data plane data tier 950 can include DB subnet(s) 930 that can be communicatively coupled to the service gateway 936 contained in the data plane VCN 918.

The untrusted app subnet(s) 962 can include one or more primary VNICs 964(1)-(N) that can be communicatively coupled to tenant virtual machines (VMs) 966(1)-(N). Each tenant VM 966(1)-(N) can be communicatively coupled to a respective app subnet 967(1)-(N) that can be contained in respective container egress VCNs 968(1)-(N) that can be contained in respective customer tenancies 970(1)-(N). Respective secondary VNICs 972(1)-(N) can facilitate communication between the untrusted app subnet(s) 962 contained in the data plane VCN 918 and the app subnet contained in the container egress VCNs 968(1)-(N). Each container egress VCNs 968(1)-(N) can include a NAT gateway 938 that can be communicatively coupled to public Internet 954 (e.g. public Internet 754 of FIG. 7).

The Internet gateway 934 contained in the control plane VCN 916 and contained in the data plane VCN 918 can be communicatively coupled to a metadata management service 952 (e.g. the metadata management system 752 of FIG. 7) that can be communicatively coupled to public Internet 954. Public Internet 954 can be communicatively coupled to the NAT gateway 938 contained in the control plane VCN 916 and contained in the data plane VCN 918. The service gateway 936 contained in the control plane VCN 916 and contained in the data plane VCN 918 can be communicatively couple to cloud services 956.

In some embodiments, the data plane VCN 918 can be integrated with customer tenancies 970. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane tier app 946. Code to run the function may be executed in the VMs 966(1)-(N), and the code may not be configured to run anywhere else on the data plane VCN 918. Each VM 966(1)-(N) may be connected to one customer tenancy 970. Respective containers 971(1)-(N) contained in the VMs 966(1)-(N) may be configured to run the code. In this case, there can be a dual isolation (e.g., the containers 971(1)-(N) running code, where the containers 971(1)-(N) may be contained in at least the VM 966(1)-(N) that are contained in the untrusted app subnet(s) 962), which may help prevent incorrect or otherwise undesirable code from damaging the network of the IaaS provider or from damaging a network of a different customer. The containers 971(1)-(N) may be communicatively coupled to the customer tenancy 970 and may be configured to transmit or receive data from the customer tenancy 970. The containers 971(1)-(N) may not be configured to transmit or receive data from any other entity in the data plane VCN 918. Upon completion of running the code, the IaaS provider may kill or otherwise dispose of the containers 971(1)-(N).

In some embodiments, the trusted app subnet(s) 960 may run code that may be owned or operated by the IaaS provider. In this embodiment, the trusted app subnet(s) 960 may be communicatively coupled to the DB subnet(s) 930 and be configured to execute CRUD operations in the DB subnet(s) 930. The untrusted app subnet(s) 962 may be communicatively coupled to the DB subnet(s) 930, but in this embodiment, the untrusted app subnet(s) may be configured to execute read operations in the DB subnet(s) 930. The containers 971(1)-(N) that can be contained in the VM 966(1)-(N) of each customer and that may run code from the customer may not be communicatively coupled with the DB subnet(s) 930.

In other embodiments, the control plane VCN 916 and the data plane VCN 918 may not be directly communicatively coupled. In this embodiment, there may be no direct communication between the control plane VCN 916 and the data plane VCN 918. However, communication can occur indirectly through at least one method. An LPG 910 may be established by the IaaS provider that can facilitate communication between the control plane VCN 916 and the data plane VCN 918. In another example, the control plane VCN 916 or the data plane VCN 918 can make a call to cloud services 956 via the service gateway 936. For example, a call to cloud services 956 from the control plane VCN 916 can include a request for a service that can communicate with the data plane VCN 918.

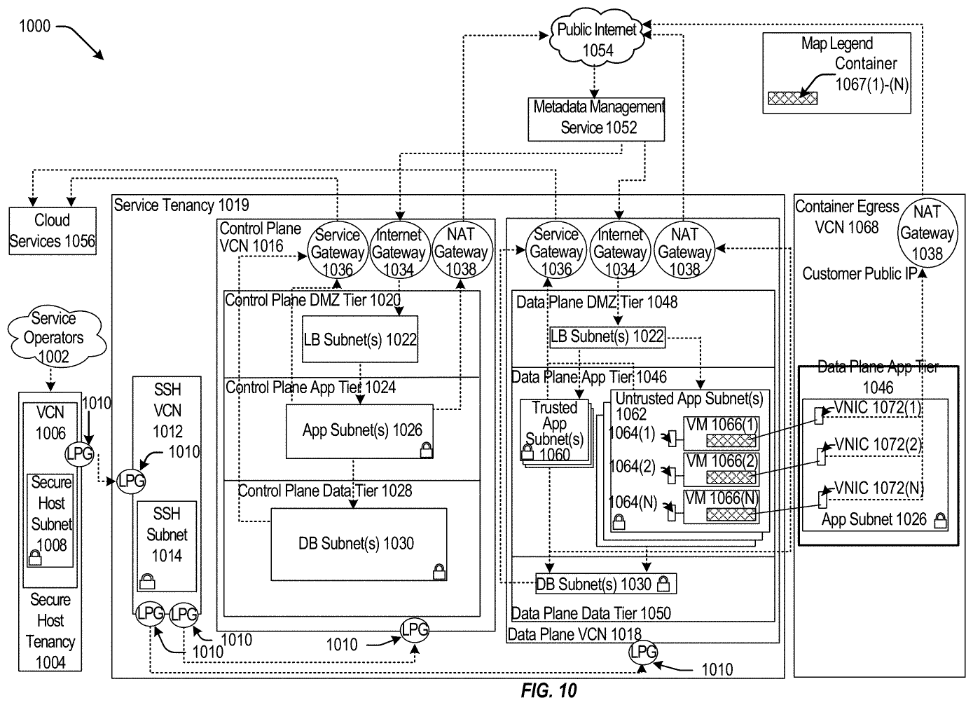

FIG. 10 is a block diagram 1000 illustrating another example pattern of an IaaS architecture, according to at least one embodiment. Service operators 1002 (e.g. service operators 702 of FIG. 7) can be communicatively coupled to a secure host tenancy 1004 (e.g. the secure host tenancy 704 of FIG. 7) that can include a virtual cloud network (VCN) 1006 (e.g. the VCN 706 of FIG. 7) and a secure host subnet 1008 (e.g. the secure host subnet 708 of FIG. 7). The VCN 1006 can include an LPG 1010 (e.g. the LPG 710 of FIG. 7) that can be communicatively coupled to an SSH VCN 1012 (e.g. the SSH VCN 712 of FIG. 7) via an LPG 1010 contained in the SSH VCN 1012. The SSH VCN 1012 can include an SSH subnet 1014 (e.g. the SSH subnet 714 of FIG. 7), and the SSH VCN 1012 can be communicatively coupled to a control plane VCN 1016 (e.g. the control plane VCN 716 of FIG. 7) via an LPG 1010 contained in the control plane VCN 1016 and to a data plane VCN 1018 (e.g. the data plane 718 of FIG. 7) via an LPG 1010 contained in the data plane VCN 1018. The control plane VCN 1016 and the data plane VCN 1018 can be contained in a service tenancy 1019 (e.g. the service tenancy 719 of FIG. 7).

The control plane VCN 1016 can include a control plane DMZ tier 1020 (e.g. the control plane DMZ tier 720 of FIG. 7) that can include LB subnet(s) 1022 (e.g. LB subnet(s) 722 of FIG. 7), a control plane app tier 1024 (e.g. the control plane app tier 724 of FIG. 7) that can include app subnet(s) 1026 (e.g. app subnet(s) 726 of FIG. 7), a control plane data tier 1028 (e.g. the control plane data tier 728 of FIG. 7) that can include DB subnet(s) 1030 (e.g. DB subnet(s) 930 of FIG. 9). The LB subnet(s) 1022 contained in the control plane DMZ tier 1020 can be communicatively coupled to the app subnet(s) 1026 contained in the control plane app tier 1024 and to an Internet gateway 1034 (e.g. the Internet gateway 734 of FIG. 7) that can be contained in the control plane VCN 1016, and the app subnet(s) 1026 can be communicatively coupled to the DB subnet(s) 1030 contained in the control plane data tier 1028 and to a service gateway 1036 (e.g. the service gateway of FIG. 7) and a network address translation (NAT) gateway 1038 (e.g. the NAT gateway 738 of FIG. 7). The control plane VCN 1016 can include the service gateway 1036 and the NAT gateway 1038.

The data plane VCN 1018 can include a data plane app tier 1046 (e.g. the data plane app tier 746 of FIG. 7), a data plane DMZ tier 1048 (e.g. the data plane DMZ tier 748 of FIG. 7), and a data plane data tier 1050 (e.g. the data plane data tier 750 of FIG. 7). The data plane DMZ tier 1048 can include LB subnet(s) 1022 that can be communicatively coupled to trusted app subnet(s) 1060 (e.g. trusted app subnet(s) 960 of FIG. 9) and untrusted app subnet(s) 1062 (e.g. untrusted app subnet(s) 962 of FIG. 9) of the data plane app tier 1046 and the Internet gateway 1034 contained in the data plane VCN 1018. The trusted app subnet(s) 1060 can be communicatively coupled to the service gateway 1036 contained in the data plane VCN 1018, the NAT gateway 1038 contained in the data plane VCN 1018, and DB subnet(s) 1030 contained in the data plane data tier 1050. The untrusted app subnet(s) 1062 can be communicatively coupled to the service gateway 1036 contained in the data plane VCN 1018 and DB subnet(s) 1030 contained in the data plane data tier 1050. The data plane data tier 1050 can include DB subnet(s) 1030 that can be communicatively coupled to the service gateway 1036 contained in the data plane VCN 1018.

The untrusted app subnet(s) 1062 can include primary VNICs 1064(1)-(N) that can be communicatively coupled to tenant virtual machines (VMs) 1066(1)-(N) residing within the untrusted app subnet(s) 1062. Each tenant VM 1066(1)-(N) can run code in a respective container 1067(1)-(N), and be communicatively coupled to an app subnet 1026 that can be contained in a data plane app tier 1046 that can be contained in a container egress VCN 1068. Respective secondary VNICs 1072(1)-(N) can facilitate communication between the untrusted app subnet(s) 1062 contained in the data plane VCN 1018 and the app subnet contained in the container egress VCN 1068. The container egress VCN can include a NAT gateway 1038 that can be communicatively coupled to public Internet 1054 (e.g. public Internet 754 of FIG. 7).

The Internet gateway 1034 contained in the control plane VCN 1016 and contained in the data plane VCN 1018 can be communicatively coupled to a metadata management service 1052 (e.g. the metadata management system 752 of FIG. 7) that can be communicatively coupled to public Internet 1054. Public Internet 1054 can be communicatively coupled to the NAT gateway 1038 contained in the control plane VCN 1016 and contained in the data plane VCN 1018. The service gateway 1036 contained in the control plane VCN 1016 and contained in the data plane VCN 1018 can be communicatively couple to cloud services 1056.

In some examples, the pattern illustrated by the architecture of block diagram 1000 of FIG. 10 may be considered an exception to the pattern illustrated by the architecture of block diagram 900 of FIG. 9 and may be desirable for a customer of the IaaS provider if the IaaS provider cannot directly communicate with the customer (e.g., a disconnected region). The respective containers 1067(1)-(N) that are contained in the VMs 1066(1)-(N) for each customer can be accessed in real-time by the customer. The containers 1067(1)-(N) may be configured to make calls to respective secondary VNICs 1072(1)-(N) contained in app subnet(s) 1026 of the data plane app tier 1046 that can be contained in the container egress VCN 1068. The secondary VNICs 1072(1)-(N) can transmit the calls to the NAT gateway 1038 that may transmit the calls to public Internet 1054. In this example, the containers 1067(1)-(N) that can be accessed in real-time by the customer can be isolated from the control plane VCN 1016 and can be isolated from other entities contained in the data plane VCN 1018. The containers 1067(1)-(N) may also be isolated from resources from other customers.

In other examples, the customer can use the containers 1067(1)-(N) to call cloud services 1056. In this example, the customer may run code in the containers 1067(1)-(N) that requests a service from cloud services 1056. The containers 1067(1)-(N) can transmit this request to the secondary VNICs 1072(1)-(N) that can transmit the request to the NAT gateway that can transmit the request to public Internet 1054. Public Internet 1054 can transmit the request to LB subnet(s) 1022 contained in the control plane VCN 1016 via the Internet gateway 1034. In response to determining the request is valid, the LB subnet(s) can transmit the request to app subnet(s) 1026 that can transmit the request to cloud services 1056 via the service gateway 1036.

It should be appreciated that IaaS architectures 700, 800, 900, 1000 depicted in the figures may have other components than those depicted. Further, the embodiments shown in the figures are only some examples of a cloud infrastructure system that may incorporate certain embodiments. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

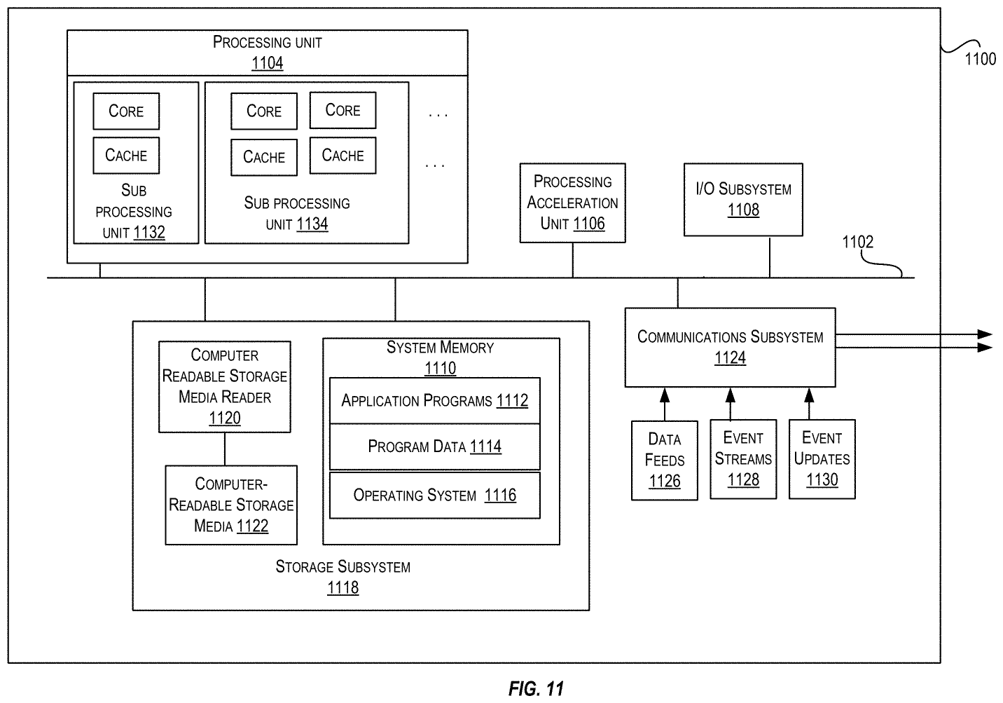

FIG. 11 illustrates an example computer system 1100, that may be used to implement various embodiments. The system 1100 may be used to implement any of the computer systems described above. As shown in the figure, computer system 1100 includes a processing unit 1104 that communicates with a number of peripheral subsystems via a bus subsystem 1102. These peripheral subsystems may include a processing acceleration unit 1106, an I/O subsystem 1108, a storage subsystem 1118 and a communications subsystem 1124. Storage subsystem 1118 includes tangible computer-readable storage media 1122 and a system memory 119.

Bus subsystem 1102 provides a mechanism for letting the various components and subsystems of computer system 1100 communicate with each other as intended. Although bus subsystem 1102 is shown schematically as a single bus, alternative embodiments of the bus subsystem may utilize multiple buses. Bus subsystem 1102 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1104, which can be implemented as one or more integrated circuits (e.g., a conventional microprocessor or microcontroller), controls the operation of computer system 1100. One or more processors may be included in processing unit 1104. These processors may include single core or multicore processors. In certain embodiments, processing unit 1104 may be implemented as one or more independent processing units 1132 and/or 1134 with single or multicore processors included in each processing unit. In other embodiments, processing unit 1104 may also be implemented as a quad-core processing unit formed by integrating two dual-core processors into a single chip.

In various embodiments, processing unit 1104 can execute a variety of programs in response to program code and can maintain multiple concurrently executing programs or processes. At any given time, some or all of the program code to be executed can be resident in processor(s) 1104 and/or in storage subsystem 1118. Through suitable programming, processor(s) 1104 can provide various functionalities described above. Computer system 1100 may additionally include a processing acceleration unit 1106, which can include a digital signal processor (DSP), a special-purpose processor, and/or the like.

I/O subsystem 1108 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1100 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1100 may comprise a storage subsystem 1118 that comprises software elements, shown as being currently located within a system memory 1110. System memory 1110 may store program instructions that are loadable and executable on processing unit 1104, as well as data generated during the execution of these programs.

Depending on the configuration and type of computer system 1100, system memory 1110 may be volatile (such as random access memory (RAM)) and/or non-volatile (such as read-only memory (ROM), flash memory, etc.) The RAM typically contains data and/or program modules that are immediately accessible to and/or presently being operated and executed by processing unit 1104. In some implementations, system memory 1110 may include multiple different types of memory, such as static random access memory (SRAM) or dynamic random access memory (DRAM). In some implementations, a basic input/output system (BIOS), containing the basic routines that help to transfer information between elements within computer system 1100, such as during start-up, may typically be stored in the ROM. By way of example, and not limitation, system memory 1110 also illustrates application programs 1112, which may include client applications, Web browsers, mid-tier applications, relational database management systems (RDBMS), etc., program data 1114, and an operating system 1116. By way of example, operating system 1116 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® 11 OS, and Palm® OS operating systems.

Storage subsystem 1118 may also provide a tangible computer-readable storage medium for storing the basic programming and data constructs that provide the functionality of some embodiments. Software (programs, code modules, instructions) that when executed by a processor provide the functionality described above may be stored in storage subsystem 1118. These software modules or instructions may be executed by processing unit 1104. Storage subsystem 1118 may also provide a repository for storing data used in accordance with the present disclosure.

Storage subsystem 1100 may also include a computer-readable storage media reader 1160 that can further be connected to computer-readable storage media 1122. Together and, optionally, in combination with system memory 1110, computer-readable storage media 1122 may comprehensively represent remote, local, fixed, and/or removable storage devices plus storage media for temporarily and/or more permanently containing, storing, transmitting, and retrieving computer-readable information.

Computer-readable storage media 1122 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 1100.

By way of example, computer-readable storage media 1122 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1122 may include, but is not limited to, Zip® drives, flash memory cards, universal serial bus (USB) flash drives, secure digital (SD) cards, DVD disks, digital video tape, and the like. Computer-readable storage media 1122 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 1100.

Communications subsystem 1124 provides an interface to other computer systems and networks. Communications subsystem 1124 serves as an interface for receiving data from and transmitting data to other systems from computer system 1100. For example, communications subsystem 1124 may enable computer system 1100 to connect to one or more devices via the Internet. In some embodiments communications subsystem 1124 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1124 can provide wired network connectivity (e.g., Ethernet) in addition to or instead of a wireless interface.

In some embodiments, communications subsystem 1124 may also receive input communication in the form of structured and/or unstructured data feeds 1126, event streams 1128, event updates 1130, and the like on behalf of one or more users who may use computer system 1100.

By way of example, communications subsystem 1124 may be configured to receive data feeds 1126 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1124 may also be configured to receive data in the form of continuous data streams, which may include event streams 1128 of real-time events and/or event updates 1130, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 1124 may also be configured to output the structured and/or unstructured data feeds 1126, event streams 1128, event updates 1130, and the like to one or more databases that may be in communication with one or more streaming data source computers coupled to computer system 1100.

Computer system 1100 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1100 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the claims is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the disclosed embodiments. Embodiments may be implemented only in hardware, or only in software, or using combinations thereof. The various processes described herein can be implemented on the same processor or different processors in any combination. Accordingly, where components or modules are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the claimed embodiments.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate certain embodiments and does not pose a limitation on the scope of the disclosed techniques. No language in the specification should be construed as indicating any non-claimed element as essential to the practice of the claimed embodiments.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments are described herein, including the best mode known for carrying out the various embodiments. Variations of those preferred embodiments may become apparent to those of ordinary skill in the art upon reading the foregoing description. Those of ordinary skill should be able to employ such variations as appropriate and the described embodiments may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, novel aspects are described with reference to specific embodiments thereof, but those skilled in the art will recognize that the disclosure is not limited thereto. Various features and aspects of the above-described embodiments may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A computer implemented method, comprising:
receiving, by a first computing device, an input data point and model information identifying a trained model that is to be used to generate a prediction for the input data point;
performing, by the first computing device, a set of one or more drift checks for the input data point and for the trained model using training dataset profile information for the trained model, the set of one or more drift checks including a first drift check, wherein the training dataset profile information for the trained model comprises information about a training dataset used to train and generate the trained model, and wherein performing the set of one or more drift checks comprises comparing the input data point to the training dataset profile information; and
generating, by the first computing device, a report comprising information identifying at least the first drift check and an associated first result generated from performing the first drift check; and
outputting the report.

2. The computer implemented method of claim 1, further comprising:
receiving, by a second computing device, the input data point;
generating, by the second computing device, the prediction for the input data point using the trained model;
wherein the outputting the report comprises communicating the report from the first computing device to the second computing device; and
outputting, by the second computing device, the prediction along with the report.

3. The computer implemented method of claim 1, further comprising:
accessing, by the first computing device and based upon the model information, the training dataset profile information from a memory location.

4. The computer implemented method of claim 1, further comprising:
identifying, by the first computing device, the training dataset used to train and generate the trained model; and
generating, by the first computing device, at least a portion of the training dataset profile information based upon the training dataset.

5. The computer implemented method of claim 1, wherein:
the training dataset comprises a plurality of training input data points, each training data point in the plurality of training input data points comprising a plurality of columns;
the training dataset profile information comprises information identifying the plurality of columns;
comparing the input data point to the training dataset profile information comprises determining whether the input data point comprises a value for each column in the plurality of columns.

6. The computer implemented method of claim 1, wherein:
the training dataset comprises a plurality of training input data points, each training input data point in the plurality of training input data points comprising a plurality of columns;
the training dataset profile information comprises, for a first column in the plurality of columns, information identifying a set of metrics determined based upon numerical values in the first column for the plurality of training input data points; and
comparing the input data point to the training dataset profile information comprises:
for a particular column in the input data point corresponding to the first column, comparing a value in the particular column in the input data point to one or more metrics in the set of metrics.

7. The computer implemented method of claim 6, wherein:
the set of metrics includes a first metric indicative of a lowest numerical value in the first column in the training dataset and a second metric indicative of a highest numerical value in the first column in the training dataset;
comparing the value in the particular column in the input data point to one or more metrics in the set of metrics comprises determining whether the value in the particular column is lower than the first metric and higher than the second metric.

8. The computer implemented method of claim 6, wherein:
the set of metrics includes a first metric indicative of a mean values based upon numerical values in the first column in the training dataset;
comparing the value in the particular column in the input data point to one or more metrics in the set of metrics comprises comparing the value in the particular column to the first metric.

9. The computer implemented method of claim 1, wherein:
the training dataset comprises a plurality of training input data points, each training input data point in the plurality of training input data points comprising a plurality of columns;
the training dataset profile information comprises, for a first column in the plurality of columns, information identifying a set of different categorical values in the first column for the plurality of training input data points;
comparing the input data point to the training dataset profile information comprises:
for a particular column in the input data point corresponding to the first column, comparing a value in the particular column in the input data point to the set of different categorical values.

10. The computer implemented method of claim 1, wherein:
the training dataset comprises a plurality of training input data points, each training input data point in the plurality of training input data points comprising a plurality of columns, the plurality of columns corresponding to a plurality of column types;
the training dataset profile information comprises information indicative of the plurality of column types;
comparing the input data point to the training dataset profile information comprises:
for a set of column types corresponding to a set of columns in the input data point, determining if the set of column types is same as the plurality of column types indicated in the training dataset profile information.

11. The computer implemented method of claim 1, wherein performing the set of one or more drift checks comprises:
for at least one drift check in the set of one or more drift checks, calling a serverless function to perform the at least one drift check.

12. The computer implemented method of claim 1, wherein:
the training dataset comprises a plurality of training input data points, each training input data point in the plurality of training input data points comprising a plurality of columns;
the training dataset profile information comprises, for a first column in the plurality of columns, information identifying a particular unit of measure associated with values in the first column in the plurality of training input data points; and
comparing the input data point to the training dataset profile information comprises:
for a particular column in the input data point corresponding to the first column, determining whether a unit of measure associated with a value in the particular column in the input data point is same as or different from the particular unit of measure.

13. A system comprising:
one or more computing devices;
one or more processors; and
a memory including instructions that, when executed by the one or more processors, cause the computing system to perform processing comprising:
receiving, by a first computing device of the one or more computing devices, an input data point and model information identifying a trained model that is to be used to generate a prediction for the input data point;
performing, by the first computing device, a set of one or more drift checks for the input data point and for the trained model using training dataset profile information for the trained model, the set of one or more drift checks including a first drift check, wherein the training dataset profile information for the trained model comprises information about a training dataset used to train and generate the trained model, and wherein performing the set of one or more drift checks comprises comparing the input data point to the training dataset profile information; and
generating, by the first computing device, a report comprising information identifying at least the first drift check and an associated first result generated from performing the first drift check; and
outputting the report.

14. The system of claim 13, wherein the processing further comprises:
receiving, by a second computing device of the one or more computing devices, the input data point;
generating, by the second computing device, the prediction for the input data point using the trained model;
wherein the outputting the report comprises communicating the report from the first computing device to the second computing device; and
outputting, by the second computing device, the prediction along with the report.

15. The system of claim 13, wherein the processing further comprises accessing, by the first computing device and based upon the model information, the training dataset profile information from a memory location.

16. The system of claim 13, wherein the processing further comprises:
identifying, by the first computing device, the training dataset used to train and generate the trained model; and
generating, by the first computing device, at least a portion of the training dataset profile information based upon the training dataset.

17. The system of claim 13, wherein:
the training dataset comprises a plurality of training input data points, each training data point in the plurality of training input data points comprising a plurality of columns;
the training dataset profile information comprises information identifying the plurality of columns;
comparing the input data point to the training dataset profile information comprises determining whether the input data point comprises a value for each column in the plurality of columns.

18. The system of claim 13, wherein:
the training dataset comprises a plurality of training input data points, each training input data point in the plurality of training input data points comprising a plurality of columns;
the training dataset profile information comprises, for a first column in the plurality of columns, information identifying a set of metrics determined based upon numerical values in the first column for the plurality of training input data points; and
comparing the input data point to the training dataset profile information comprises:
for a particular column in the input data point corresponding to the first column, comparing a value in the particular column in the input data point to one or more metrics in the set of metrics.

19. A non-transitory computer-readable medium storing a plurality of instructions executable by one or more processors, and when executed by the one or more processors cause the one or more processors to perform processing comprising:
receiving, by a first computing device, an input data point and model information identifying a trained model that is to be used to generate a prediction for the input data point;
performing, by the first computing device, a set of one or more drift checks for the input data point and for the trained model using training dataset profile information for the trained model, the set of one or more drift checks including a first drift check, wherein the training dataset profile information for the trained model comprises information about a training dataset used to train and generate the trained model, and wherein performing the set of one or more drift checks comprises comparing the input data point to the training dataset profile information; and
generating, by the first computing device, a report comprising information identifying at least the first drift check and an associated first result generated from performing the first drift check; and
outputting the report.

20. The non-transitory computer-readable medium of claim 19, wherein the processing further comprises:
receiving, by a second computing device, the input data point;
generating, by the second computing device, the prediction for the input data point using the trained model;
wherein the outputting the report comprises communicating the report from the first computing device to the second computing device; and
outputting, by the second computing device, the prediction along with the report.
